(19) United States
(12) Patent Application Publication
(10) Pub. No.: US 2023/0406967 A1
(43) Pub. Date: Dec. 21, 2023

(54) Non-Aromatic Hydrocarbon Soluble Olefin Polymerization Catalysts and Use Thereof

(71) Applicant: ExxonMobil Chemical Patents Inc., Baytown, TX (US)

(72) Inventors: Catherine A. FALER, Houston, TX (US); Margaret T. WHALLEY, Houston, TX (US)

(21) Appl. No.: 18/250,245

(22) PCT Filed: Oct. 26, 2021
(86) PCT No.: PCT/US2021/056642

§ 371 Date: Apr. 24, 2023

Related U.S. Application Data
(60) Provisional application No. 63/106,774, filed on Oct. 28, 2020.

(51) Int. Cl. C08F 4/659; C08F 210/16

(52) U.S. Cl. CPC C08F 4/65908; C08F 4/65912; C08F 4/65916; C08F 210/16

(57) ABSTRACT

The invention relates to a non-aromatic hydrocarbon soluble catalyst compound represented by the formula: wherein: M is a Group 4 metal; each X is independently a leaving group, such as an anionic leaving group; m is 1, 2 or 3; L is a Group 15 or 16 element; Y and Z are independently phosphorus, nitrogen sulfur, or oxygen; R¹ and R² are, independently, a C₁ to C₂₀ (such as C₁ to C₃) hydrocarbon group, a heteroatom containing group, silicon, germanium, tin, lead, or phosphorus, or R¹ and R² are interconnected to each other; R³ may be absent or may be a hydrocarbon group, a hydrogen, a halogen, a heteroatom containing group; and each R⁴ and R⁵ is independently a substituted C₅ to C₂₂ aromatic group, wherein the catalyst compound is soluble in non-aromatic hydrocarbons.

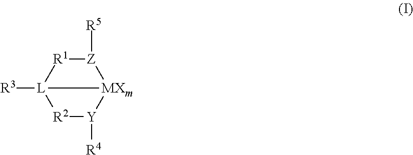

### CROSS-REFERENCE TO RELATED APPLICATIONS

This application claims the benefit of and priority to U.S. Provisional Application No. 62/106,774 filed Oct. 28, 2020, the disclosure of which is incorporated herein by reference.

### FIELD OF THE INVENTION

This invention relates to novel group 4 catalyst compounds where the catalyst compounds are soluble in non-aromatic hydrocarbon solvents, catalyst systems comprising such compounds, and uses thereof.

### BACKGROUND OF THE INVENTION

Olefin polymerization catalysts are of great use in industry. Hence there is interest in finding new catalyst systems that increase the commercial usefulness of the catalyst and allow the production of polymers having improved properties.

Catalysts for olefin polymerization are often based on group 4 metal compounds used as catalyst precursors, which are activated typically with the help of activator comprising alumoxane or non-coordinating anion.

Liang, L. et al (1999) “Synthesis of Group 4 Complexes that Contain the Diamidoamine Ligands, [(2,4,6-Me₃C₆H₂NCH₂CH₂NR]²⁻,” J. Amer. Chem. Soc., v.121, pp. 5797-5798 disclose zirconium complexes that contain a [(2,4,6-Me₃C₆H₂NCH₂CH₂)₂NR]₂-([Mes₂N₂NR]₂—; R) H or Me) ligand.

Barlow, I. et al (2010) “Synthesis, Monolayer Formation, Characterization, and Nanometer-Scale Photolithographic Patterning of Conjugated Oligomers Bearing Terminal Thioacetates,” Langmuir, v.26(6), pp. 4449-4458, disclose a synthesis of 1-bromo-4-decylbenzene.

Other references of interest include: WO2019/191539; WO2010/014344; US 2002/0062011; US 2019/0330392; US 2019/0330139; U.S. Pat. Nos. 10,604,605; 9,718,900; U.S. Pat. Nos. 7,718,566; 8,642,497; 9,714,305; 9,644,053; 9,221,937; 7,193,017; 7,181,371; 7,101,940; 6,967,184; 5,919,983; 7,799,879; 7,985,816; 8,580,902; 6,248,845; 6,492,472; WO2020/096734; WO2020/096735; WO2020/096732; U.S. Pat. No. 8,501,659; WO 2010/053696; and U.S. Pat. No. 8,835,587.

There is still a need in the art for new and improved, preferably non-aromatic hydrocarbon soluble, catalyst systems for the polymerization of olefins, in order to achieve specific polymer properties, such as high melting point, high molecular weights, to increase conversion or comonomer incorporation, or to alter comonomer distribution and/or molecular weight distribution without negatively impacting the resulting polymer's additional properties.

It is therefore an object of the present invention to provide novel catalyst compounds, catalysts systems comprising such compounds that are preferably non-aromatic hydrocarbon soluble, and processes for the polymerization of olefins using such compounds and systems.

### SUMMARY OF THE INVENTION

This invention relates to non-aromatic hydrocarbon soluble catalyst compounds, and catalyst systems comprising such compounds, represented by the Formula (X):

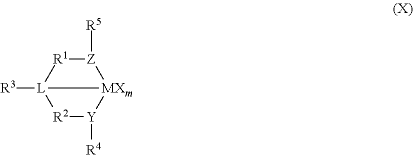

wherein:
M is a Group 4 metal;
each X is independently a leaving group, such as an anionic leaving group;
m is 1, 2 or 3;
L is a Group 15 or 16 element;
Y and Z are independently phosphorus, nitrogen sulfur, or oxygen;
R¹ and R² are, independently, a C₁ to C₂₀ hydrocarbon group a heteroatom containing group having up to twenty carbon atoms, silicon, germanium, tin, lead, or phosphorus, R¹ and R² may also be interconnected to each other directly or bound to each other through other groups);
R³ may be absent or may be a hydrocarbon group, a hydrogen, a halogen, a heteroatom containing group; and
each R⁴ and R⁵ is independently a substituted C₅ to C₂₂ substituted aromatic group, wherein the catalyst compound is soluble in methylcyclohexane at greater than 10 weight percent (and/or optionally greater than 1.5 weight percent in isohexane) at 25° C.

This invention further relates to novel catalyst systems comprising an activator and one or more of the catalyst compounds described above.

This invention relates to a method to polymerize olefins comprising contacting a catalyst compound described above with an activator and one or more monomers.

This invention further relates to polymer compositions produced by the methods described herein.

### BRIEF DESCRIPTION OF THE FIGURES

FIG. 1 (FIG. 1) is a graph of activity for Catalysts: Cat-1, Cat-2, and Cat-4).

FIG. 2 (FIG. 2) is a graph of Mw for Catalysts: Cat-1, Cat-2, and Cat-4).

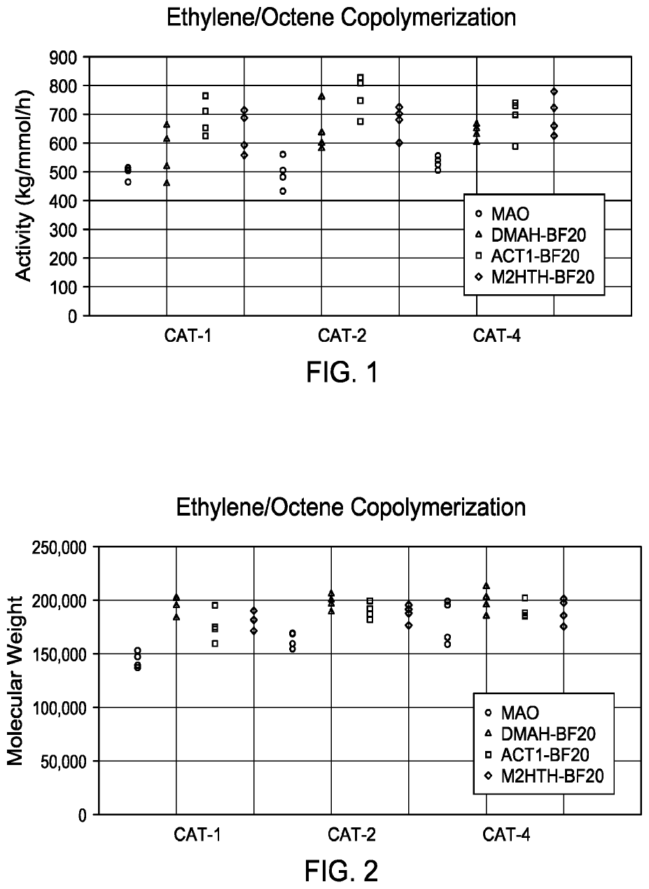

### DETAILED DESCRIPTION

### Definitions

For the purposes of this invention and the claims thereto, the new numbering scheme for the Periodic Table Groups is used as described in Chemical and Engineering News, v.63(5), pg. 27 (1985). Therefore, a “group 4 metal” is an element from group 4 of the Periodic Table, e.g. Hf, Ti, or Zr.

For purposes of this specification and the claims appended thereto, when a polymer or copolymer is referred to as comprising an olefin, the olefin present in such polymer or copolymer is the polymerized form of the olefin. For example, when a copolymer is said to have an “ethylene” content of 35 wt % to 55 wt %, it is understood that the mer unit in the copolymer is derived from ethylene in the polymerization reaction and said derived units are present at 35 wt % to 55 wt %, based upon the weight of the copolymer. A “polymer” has two or more of the same or different mer units. A “homopolymer” is a polymer having mer units that are the same. A “copolymer” is a polymer having two or more mer units that are different from each other. A “terpolymer” is a polymer having three mer units that are different from each other. Accordingly, the definition of copolymer, as used herein, includes terpolymers and the like. “Different” as used to refer to mer units indicates that the mer units differ from each other by at least one atom or are different isomerically. An “ethylene polymer” or “ethylene copolymer” is a polymer or copolymer comprising at least 50 mole % ethylene derived units, a “propylene polymer” or “propylene copolymer” is a polymer or copolymer comprising at least 50 mole % propylene derived units, and so on.

The term “alpha-olefin” refers to an olefin having a terminal carbon-to-carbon double bond in the structure thereof ((R¹R²)—C═CH₂, where R¹ and R² can be independently hydrogen or any hydrocarbyl group; preferably R¹ is hydrogen and R² is an alkyl group). A “linear alpha-olefin” is an alpha-olefin defined in this paragraph wherein R¹ is hydrogen, and R² is hydrogen or a linear alkyl group.

For the purposes of this invention, ethylene shall be considered an α-olefin.

The term “hydrocarbon” means compounds of hydrogen and carbon which may be saturated or unsaturated.

The terms “group,” “radical,” and “substituent” may be used interchangeably.

The terms “hydrocarbyl radical,” “hydrocarbyl group,” or “hydrocarbyl” may be used interchangeably and are defined to mean a group consisting of hydrogen and carbon atoms only. Preferred hydrocarbyls are C₁-C₁₀₀ radicals that may be linear, branched, or cyclic, and when cyclic, aromatic or non-aromatic. Examples of such radicals include, but are not limited to, alkyl groups such as methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, and the like, aryl groups, such as phenyl, benzyl naphthyl, and the like.

Unless otherwise indicated, (e.g., the definition of “substituted hydrocarbyl”, “substituted aromatic,” “substituted aryl,” etc.), the term “substituted” means that at least one hydrogen atom has been replaced with at least one non-hydrogen group, such as a hydrocarbyl group, a heteroatom, or a heteroatom containing group, such as halogen (such as Br, Cl, F or I) or at least one functional group such as —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, —(CH₂)q-SiR*₃, and the like, where q is 1 to 10 and each R* is independently hydrogen, a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring.

The term “substituted hydrocarbyl” means a hydrocarbyl radical in which at least one hydrogen atom of the hydrocarbyl radical has been substituted with at least one heteroatom (such as halogen, e.g., Br, Cl, F or I) or heteroatom-containing group (such as a functional group, e.g., —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, —(CH₂)q-SiR*₃, and the like, where q is 1 to 10 and each R* is independently hydrogen, a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring.

The term “substituted phenyl,” mean a phenyl group having 1 or more hydrogen groups replaced by a hydrocarbyl, substituted hydrocarbyl, heteroatom or heteroatom containing group.

The term “hydrocarbyl substituted phenyl” means a phenyl group having 1, 2, 3, 4 or 5 hydrogen groups replaced by a hydrocarbyl or substituted hydrocarbyl group. Preferably the “hydrocarbyl substituted phenyl” group is represented by the formula:

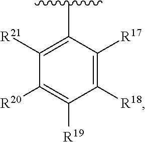

where each of R¹⁷, R¹⁸, R¹⁹, R²⁰, and R²¹ is independently selected from hydrogen, C₁-C₄₀ hydrocarbyl or C₁-C₄₀ substituted hydrocarbyl, a heteroatom or a heteroatom-containing group (provided that at least one of R¹⁷, R¹⁸, R¹⁹, R²⁰, and R²¹ is not H), or two or more of R¹⁷, R¹⁸, R¹⁹, R²⁰, and R²¹ are joined together to form a C₄-C₆₂ cyclic or polycyclic ring structure, or a combination thereof.

The term “substituted naphthyl,” means a naphthyl group having 1 or more hydrogen groups replaced by a hydrocarbyl, substituted hydrocarbyl, heteroatom or heteroatom containing group.

The term “substituted anthracenyl,” means an anthracenyl group having 1 or more hydrogen groups replaced by a hydrocarbyl, substituted hydrocarbyl, heteroatom or heteroatom containing group.

The term “substituted benzyl” means a benzyl group having 1 or more hydrogen groups replaced by a hydrocarbyl, substituted hydrocarbyl, heteroatom or heteroatom containing group, preferably a substituted benzyl” group is represented by the formula:

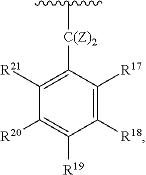

where each of R¹⁷, R¹⁸, R¹⁹, R²⁰, R²¹ and Z is independently selected from hydrogen, C₁-C₄₀ hydrocarbyl or C₁-C₄₀ substituted hydrocarbyl, a heteroatom or a heteroatom-containing group (provided that at least one of R¹⁷, R¹⁸, R¹⁹, R²⁰, R²¹ and Z is not H), or two or more of R¹⁷, R¹⁸, R¹⁹, R²⁰, R²¹ and Z are joined together to form a C₄-C₆₂ cyclic or polycyclic ring structure, or a combination thereof.

A “halocarbyl” is a halogen substituted hydrocarbyl group.

For purposes of the present disclosure, in relation to catalyst compounds, the term “substituted” means that a hydrogen group has been replaced with a hydrocarbyl group, a heteroatom, or a heteroatom containing group, such as halogen (such as Br, C₁, F or I) or at least one functional group such as —NR*₂, —OR*, —SeR*, —TeR*; —PR*₂, —AsR*₂, —SbR*₂, —SR*, —BR*₂, —SiR*₃, —GeR*₃, —SnR*₃, —PbR*₃, —(CH₂)q-SiR*₃, and the like, where q is 1 to 10 and each R* is independently hydrogen, a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring.

The terms “alkoxy” or “alkoxide” and “aryloxy” or “aryloxide” mean an alkyl or aryl group bound to an oxygen atom; such as an alkyl ether or aryl ether group/radical connected to an oxygen atom and can include those where the alkyl group is a C₁ to C₁₀ hydrocarbyl. The alkyl group may be straight chain, branched, or cyclic. The alkyl group may be saturated or unsaturated. Examples of suitable alkoxy and aryloxy radicals can include methoxy, ethoxy, n-propoxy, iso-propoxy, n-butoxy, iso-butoxy, sec-butoxy, tert-butoxy, phenoxyl, and the like.

The terms “alkyl radical,” and “alkyl” are used interchangeably throughout this disclosure. For purposes of this disclosure, “alkyl radical” is defined to be a saturated hydrocarbon radical that may be linear, branched, or cyclic. Examples of such radicals can include C₁-C₁₀₀ saturated hydrocarbon radicals (C₁-C₁₀₀ alkyls), such as methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, and the like including their substituted analogues. Substituted alkyl radicals are radicals in which at least one hydrogen atom of the alkyl radical has been substituted with at least a non-hydrogen group, such as a heteroatom, or a heteroatom containing group, such as halogen (such as Br, C₁, F or I) or at least one functional group such as —NR*₂, —OR*, —SeR*, —TeR*; —PR*₂, —AsR*₂, —SbR*₂, —SR*, —BR*₂, —SiR*₃, —GeR*₃, —SnR*₃, —PbR*₃, —(CH₂)q-SiR*₃, and the like, where q is 1 to and each R* is independently hydrogen, a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring.

The term “aryl” or “aryl group” means an aromatic ring (typically made of 6 carbon atoms), such as phenyl, where substituents on the aryl group may form completely saturated, partially unsaturated, or aromatic cyclic or polycyclic ring structure, such as naphthyl or anthracenyl. The term “substituted aryl” means a heteroaryl group or an aryl or heteroaryl group where at least one hydrogen atom has been replaced with at least one non-hydrogen group, such as a hydrocarbyl group, a heteroatom, or a heteroatom containing group, such as halogen (such as Br, C₁, F or I) or at least one functional group such as —NR*₂, —OR*, —SeR*, —TeR*, —PR*₂, —AsR*₂, —SbR*₂, —SR*. —BR*₂, —SiR*₃, —GeR*₃, —SnR*₃, —PbR*₃, —(CH₂)q-SiR*₃, and the like, where q is 1 to 10 and each R* is independently hydrogen, a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring, such as 2-methyl-phenyl, benzyl, xylyl, 4-bromo-xylyl, etc.

The term “heteroaryl” means an aryl group where a ring carbon atom (or two or three ring carbon atoms) has been replaced with a heteroatom, such as N, O, or S.

The term “ring atom” means an atom that is part of a cyclic ring structure. By this definition, a benzyl group has six ring atoms and tetrahydrofuran has 5 ring atoms.

A heterocyclic ring is a ring having a heteroatom in the ring structure as opposed to a heteroatom substituted ring where a hydrogen on a ring atom is replaced with a heteroatom. For example, tetrahydrofuran is a heterocyclic ring and 4-N,N-dimethylamino-phenyl is a heteroatom substituted ring.

An aralkyl group is defined to be an alkyl substituted aryl group. An alkaryl group is defined to be an aryl substituted alkyl group.

The term “aromatic” refers to unsaturated cyclic hydrocarbons having a delocalized conjugated 7E system. Typical aromatics comprise 5 to 20 carbon atoms (aromatic C₅-C₂₀ hydrocarbon), such as from 6 to 14 carbon atoms (aromatic C₆-C₁₄ hydrocarbon), or from 6 to 10 carbon atoms (aromatic C₆-C₁₀ hydrocarbon). Exemplary aromatics include, but are not limited to benzene, toluene, xylenes, mesitylene, ethylbenzenes, cumene, naphthalene, methylnaphthalene, dimethylnaphthalenes, ethylnaphthalenes, acenaphthalene, anthracene, phenanthrene, tetraphene, naphthacene, benzanthracenes, fluoranthrene, pyrene, chrysene, triphenylene, and the like, and combinations thereof.

The term “substituted aromatic,” means an aromatic group having one or more hydrogen groups replaced by a hydrocarbyl, substituted hydrocarbyl, heteroatom or heteroatom containing group or where a ring carbon atom (or two or three ring carbon atoms) has been replaced with a heteroatom, such as N, O, or S.

Where isomers of a named alkyl, alkenyl, alkoxide, or aryl group exist (e.g., n-butyl, iso-butyl, sec-butyl, and tert-butyl) reference to one member of the group (e.g., n-butyl) shall expressly disclose the remaining isomers (e.g., iso-butyl, sec-butyl, and tert-butyl) in the family. Likewise, reference to an alkyl, alkenyl, alkoxide, or aryl group without specifying a particular isomer (e.g., butyl) expressly discloses all isomers (e.g., n-butyl, iso-butyl, sec-butyl, and tertbutyl).

A “metallocene” catalyst compound is a transition metal catalyst compound having one, two or three, typically one or two, substituted or unsubstituted cyclopentadienyl ligands bound to the transition metal, typically a metallocene catalyst is an organometallic compound containing at least one n-bound cyclopentadienyl moiety (or substituted cyclopentadienyl moiety). Substituted or unsubstituted cyclopentadienyl ligands include substituted or unsubstituted indenyl, fluorenyl, tetrahydro-s-indacenyl, tetrahydro-as-indacenyl, benz[f]indenyl, benz[e]indenyl, tetrahydrocyclopenta[b]naphthalene, tetrahydrocyclopenta[a]naphthalene, and the like.

The term “post-metallocene” also referred to as “post-metallocene catalyst” or “post-metallocene compound” describes transition metal complexes that contain a transition metal, at least one anionic donor ligand, and at least one leaving group with a non-carbon atom directly linking to the metal (such as halogen leaving group(s)), but do not contain any it-coordinated cyclopentadienyl anion donors (e.g., it-bound cyclopentadienyl moiety or substituted cyclopentadienyl moiety), where the complexes are useful for the polymerization of olefins, typically when combined with activator(s). Post-metallocene catalysts include those first disclosed after 1980, typically after 1990.

The term “single site coordination polymerization catalyst” means metallocene or post metallocene catalyst compounds, including but not limited to pyridyldiamido complexes, quinolinyldiamido complexes, phenoxyimine complexes, bisphenolate complexes, cyclopentadienyl-amidinate complexes, and iron pyridyl bis(imine) complexes.

As used herein, Mn is number average molecular weight, Mw is weight average molecular weight, and Mz is z average molecular weight, wt % is weight percent, and mol % is mole percent. Molecular weight distribution (MWD), also referred to as polydispersity index (PDI), is defined to be Mw divided by Mn. Unless otherwise noted, all molecular weight units (e.g., Mw, Mn, Mz) are g/mol (g mol⁻¹).

The following abbreviations may be used herein: Me is methyl, Et is ethyl, Pr is propyl, cPr is cyclopropyl, nPr is n-propyl, iPr is isopropyl, Bu is butyl, nBu is normal butyl, iBu is isobutyl, sBu is sec-butyl, tBu is tert-butyl, Hx is hexyl, Cy is cyclohexyl, Oct is octyl, Ph is phenyl, MAO is methylalumoxane, dme is 1,2-dimethoxyethane, p-tBu is para-tertiary butyl, TMS is trimethylsilyl, TIBAL is triisobutylaluminum, TNOAL is tri(n-octyl)aluminum, p-Me is para-methyl, Bz and Bn are benzyl (i.e., CH₂Ph), THF (also referred to as thf) is tetrahydrofuran, RT is room temperature (and is 23° C. unless otherwise indicated), tol is toluene, EtOAc is ethyl acetate, and Cbz is Carbazole.

A “catalyst system” is a combination of at least one catalyst compound, at least one activator, an optional co-activator, and an optional support material. When “catalyst system” is used to describe such a pair before activation, it means the unactivated catalyst complex (precatalyst) together with an activator and, optionally, a co-activator. When it is used to describe such a pair after activation, it means the activated complex and the activator or other charge-balancing moiety. The transition metal compound may be neutral as in a precatalyst, or a charged species with a counter ion as in an activated catalyst system. For the purposes of this invention and the claims thereto, when catalyst systems are described as comprising neutral stable forms of the components, it is well understood by one of ordinary skill in the art, that the ionic form of the component is the form that reacts with the monomers to produce polymers. A polymerization catalyst system is a catalyst system that can polymerize monomers to polymer.

In the description herein, the catalyst may be described as a catalyst, a catalyst precursor, a pre-catalyst compound, catalyst compound or a transition metal compound, and these terms are used interchangeably.

An “anionic ligand” is a negatively charged ligand which donates one or more pairs of electrons to a metal ion. A “neutral donor ligand” is a neutrally charged ligand which donates one or more pairs of electrons to a metal ion.

The term “continuous” means a system that operates without interruption or cessation. For example a continuous process to produce a polymer would be one where the reactants are continually introduced into one or more reactors and polymer product is continually withdrawn.

### DESCRIPTION

This invention relates to non-aromatic hydrocarbon soluble catalyst compounds, and catalyst systems comprising such compounds, represented by the Formula (X):

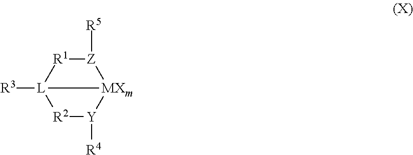

wherein:
M is a Group 4 metal, such as zirconium, titanium, or hafnium, such as zirconium;
each X is independently a leaving group, such as an anionic leaving group (such as a hydrogen, a hydrocarbyl group (such as an alkyl), a heteroatom (such as a halogen);
m is 1, 2 or 3, such as 2;
L is a Group 15 or 16 element, such as nitrogen or oxygen;
Y and Z are independently phosphorus, nitrogen sulfur, or oxygen, such as nitrogen;
R¹ and R² are, independently, a C₁ to C₂₀ (such as C₁ to C₃) hydrocarbon group, a heteroatom containing group having up to twenty carbon atoms, silicon, germanium, tin, lead, or phosphorus (such as R¹ and R² are a C₂ to C₂₀ alkyl, substituted C₂ to C₂₀ alkyl, aryl, or substituted aryl group, such as a C₂ to C₂₀ linear, branched or cyclic alkyl group), R¹ and R² may also be interconnected to each other directly or bound to each other through other groups);
R³ may be absent or may be a hydrocarbon group, a hydrogen, a halogen, a heteroatom containing group (optionally R³ is absent, for example, if L is an oxygen, or a hydrogen, or a linear, cyclic, or branched alkyl group having 1 to 20 carbon atoms);
each R⁴ and R⁵ is independently a substituted C₅ to C₂₂ aromatic group (such as a substituted aryl group), wherein the catalyst compound is soluble in methylcyclohexane at greater than 10 weight percent (optionally and/or greater than 1.5 weight percent in isohexane) at 25° C.

In embodiments of the invention, the catalyst compound is soluble in non-aromatic-hydrocarbon solvents, such as aliphatic solvents.

In embodiments, the activator is soluble in non-aromatic-hydrocarbon solvents, such as aliphatic solvents.

In embodiments of the invention, the catalyst compound(s) described herein have a solubility of more than 10 mM (or more than 20 mM, or more than 50 mM) at 25° C. (stirred 2 hours) in methylcyclohexane.

In embodiments of the invention, the catalyst compound(s) described herein have a solubility of more than 1 mM (or more than 10 mM, or more than 20 mM) at 25° C. (stirred 2 hours) in isohexane.

This invention also relates to catalyst systems comprising catalyst compounds represented by Formula (X) or (XII) below, activators, optional co-activators, and optional supports.

In any catalyst system described herein, the catalyst compound and activator are non-aromatic hydrocarbon soluble, preferably soluble in the same non-aromatic hydrocarbon.

In any catalyst system described herein, the catalyst compound and activator are soluble in non-aromatic-hydrocarbon solvents, such as aliphatic solvents, preferably soluble in the same aliphatic hydrocarbon solvent.

In one or more embodiments, a 20 wt % mixture of the catalyst compound and activator is soluble in n-hexane, isohexane, cyclohexane, methylcyclohexane, or a combination thereof, forms a clear homogeneous solution at 25° C., preferably a 30 wt % mixture of the catalyst compound and activator in n-hexane, isohexane, cyclohexane, methylcyclohexane, or a combination thereof, forms a clear homogeneous solution at 25° C.

In embodiments of the invention, the catalyst system comprising a combination of catalyst compound(s) and activators(s) described herein has a solubility of more than 10 mM (or more than 20 mM, or more than 50 mM) at 25° C. (stirred 2 hours) in methylcyclohexane.

In embodiments of the invention, the catalyst system comprising a combination of catalyst compound(s) and activators(s) described herein has a solubility of more than 1 mM (or more than 10 mM, or more than 20 mM) at 25° C. (stirred 2 hours) in isohexane.

In embodiments of the invention, the catalyst system comprising a combination of catalyst compound(s) and activators(s) described herein has a solubility of more than 10 mM (or more than 20 mM, or more than 50 mM) at 25° C. (stirred 2 hours) in methylcyclohexane and a solubility of more than 1 mM (or more than 10 mM, or more than 20 mM) at 25° C. (stirred 2 hours) in isohexane.

In a preferred embodiment, the catalyst system comprising a combination of catalyst compound(s) and activators(s) described herein, is non-aromatic-hydrocarbon (such as toluene) soluble catalyst compound.

The catalyst systems used herein preferably contain 0 ppm (alternately less than 1 ppm) of aromatic hydrocarbon. Preferably, the catalyst systems used herein contain 0 ppm (alternately less than 1 ppm) of toluene.

The present disclosure relates to a catalyst system comprising a transition metal compound and an activator compound as described herein, to the use of such activator compounds for activating a transition metal compound in a catalyst system for polymerizing olefins, and to processes for polymerizing olefins, the process comprising contacting under polymerization conditions one or more olefins with a catalyst system comprising a transition metal compound and such activator compounds, where aromatic solvents, such as toluene, are absent (e.g. present at zero mol %, alternately present at less than 1 mol %, preferably the catalyst system, the polymerization reaction and/or the polymer produced are free of “detectable aromatic hydrocarbon solvent,” such as toluene. For purposes of the present disclosure, “detectable aromatic hydrocarbon solvent” means 0.1 mg/m² or more as determined by gas phase chromatography. For purposes of the present disclosure, “detectable toluene” means 0.1 mg/m² or more as determined by gas phase chromatography.

### Catalyst Compounds

In at least one embodiment, this invention relates to non-aromatic hydrocarbon soluble catalyst compounds represented by the Formula (X):

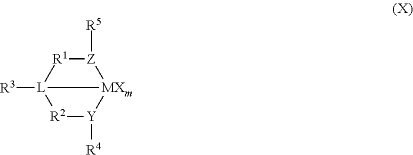

wherein:
M is a Group 4 metal, such as zirconium, titanium, or hafnium, such as zirconium;
each X is independently a leaving group, such as an anionic leaving group (such as hydrogen, a hydrocarbyl group (such as an alkyl), or a heteroatom (such as a halogen);
m is 1, 2 or 3, such as 2;
L is a Group 15 or 16 element, such as nitrogen or oxygen, such as nitrogen;
Y and Z are independently phosphorus, nitrogen sulfur, or oxygen, such as nitrogen;
R¹ and R² are, independently, a C₁ to C₂₀ hydrocarbon group (such as C₁ to C₃), a heteroatom containing group having up to twenty carbon atoms, silicon, germanium, tin, lead, or phosphorus (such as R¹ and R² are a C₂ to C₂₀ alkyl, substituted C₂ to C₂₀ alkyl, aryl, or substituted aryl group, such as a C₂ to C₁₂ (such as C₁ to C₃) linear, branched or cyclic alkyl group), R¹ and R² may also be interconnected to each other directly or bound to each other through other groups);
R³ may be absent or may be a hydrocarbon group, a hydrogen, a halogen, a heteroatom containing group (optionally R³ is absent, for example, if L is an oxygen, or a hydrogen, or a linear, cyclic, or branched alkyl group having 1 to 20 carbon atoms);
each R⁴ and R⁵ is independently a substituted C₅ to C₂₂ aromatic group (such as a substituted aryl group (such as a substituted phenyl group, a substituted benzyl group, a substituted naphthyl group, or a substituted anthracenyl group)),
wherein the catalyst compound is soluble in methylcyclohexane at greater than 10 weight percent (optionally and/or greater than 1.5 weight percent in isohexane) at 25° C.

Alternately, at least one, optionally both, of R⁴ and R⁵ is independently a C₆ to C₂₂ para-substituted phenyl group, a C₆ to C₂₂ para-substituted benzyl group, a C₆ to C₂₂ para-substituted naphthyl group, or a C₆ to C₂₂ para-substituted anthracenyl group.

Alternately, R⁴ or R⁵ is a C₆ to C₂₂ para-substituted phenyl group, a C₆ to C₂₂ para-substituted benzyl group, a C₆ to C₂₂ para-substituted naphthyl group, or a C₆ to C₂₂ para-substituted anthracenyl group.

In embodiments, each R⁴ and R⁵ is independently a hydrocarbyl substituted phenyl group represented by the formula:

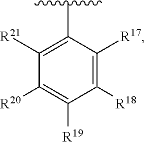

where each of R¹⁷, R¹⁸, R²⁰, and R²¹ is independently selected from hydrogen, C₁-C₄₀ hydrocarbyl or C₁-C₄₀ substituted hydrocarbyl, a heteroatom or a heteroatom-containing group, or two or more of R¹⁷, R¹⁸, R¹⁹, R²⁰, and R²¹ are joined together to form a C₄-C₆₂ cyclic or polycyclic ring structure, or a combination thereof.

Each R¹⁹ is independently selected from C₃-C₂₂ hydrocarbyl or C₁-C₂₂ substituted hydrocarbyl, a heteroatom or a heteroatom-containing group. Alternately, each R¹⁹ is independently one or more of C₃ to C₁₆ (such as C₆ to C₁₄, alternately C₈ to Cu) hydrocarbyl (such as C₃ to C₁₆ alkyl, such as linear or branched C₃ to C₁₆ alkyl, such as propyl, butyl, pentyl, hexyl, heptyl, octyl, nonyl, decyl, undecyl, dodecyl, tridecyl, tetradecyl, pentadecyl; hexadecyl, heptadecyl, phenyl, methylphenyl and dimethylphenyl, benzyl, methylbenzyl, naphthyl, cyclohexyl, cyclohexenyl, methylcyclohexyl or an isomer thereof. Alternately R¹⁹ is a linear alkyl selected from the group consisting of: propyl, butyl, pentyl, hexyl, heptyl, octyl, nonyl, decyl, undecyl, dodecyl, tridecyl, tetradecyl, pentadecyl, hexadecyl, and heptadecyl.

Alternately R¹⁹ is a linear, branched or cyclic alkenyl group. Alkenyl units contain at least one end-vinyl group also referred to as an allyl chain end. An allyl chain end is represented by the formula H₂C═CH—CH₂—. “Allylic vinyl group,” “allyl chain end,” “vinyl chain end,” “vinyl termination,” “allylic vinyl group,” “terminal vinyl group,” and “vinyl terminated” are used interchangeably herein and refer to an allyl chain end. An allyl chain end is not a vinylidene chain end or a vinylene chain end. The number of allyl chain ends, vinylidene chain ends, vinylene chain ends, and other unsaturated chain ends is determined using ¹H NMR as follows: ¹H NMR spectroscopic data for aluminum vinyl units are obtained at room temperature using a Bruker 400 MHz NMR. Data are collected using samples prepared by dissolving 10-20 mg the compound in 1 mL of C₆D₆. Samples are then loaded into 5 mm NMR tubes for data collection. Data are recorded using a maximum pulse width of 45°, 8 seconds between pulses and signal averaging either 8 or 16 transients. The spectra are normalized to protonated tetrachloroethane in the C₆D₆. The chemical shifts (δ) are reported as relative to the residual protium in the deuterated solvent at 7.15 ppm.

Useful alkenyl groups include hydrocarbenyl groups having an allyl chain end, typically represented by the formula CH₂═CH—CH₂—R—, where R represents a hydrocarbeneyl group or a substituted hydrocarbeneyl group, such as a C₁ to C₃₀ alkylene, such as C₄ to C₂₂ alkylene, preferably methylene (CH₂), ethylene [(CH₂)₂], propandiyl [(CH₂)₃], butandiyl [(CH₂)₄], pentandiyl [(CH₂)₅], hexandiyl [(CH₂)₆], heptandiyl [(CH₂)₇], octandiyl [(CH₂)₈], nonandiyl [(CH₂)₉], decandiyl [(CH₂)₁₀], undecandiyl [(CH₂)₁₁], dodecandiyl [(CH₂)₁₂], or an isomer thereof.

Alternately R¹⁹ is a mixture of isomers, such as a mixture of C₄ to C₃₀ isomers, such as a mixture of C₈ to C₂₂ isomers, such as a mixture of linear and or branched C₄ to C₂₂ isomers, such as a mixture of linear and or branched C₈ to C₂₀ isomers.

In at least one embodiment, the catalyst is a Group 15-containing metal compound represented by Formula (XII):

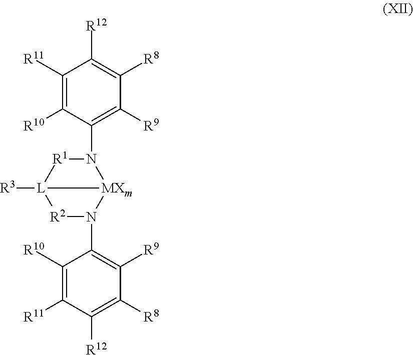

wherein:
M is a Group 4 metal, such as zirconium, titanium, or hafnium;
each X is independently a leaving group, such as an anionic leaving group (such as hydrogen, a hydrocarbyl group (such as an alkyl) or a heteroatom (such as a halogen);
m is 1, 2 or 3, typically 2;
R¹ and R² are; independently, a C₁ to C₂₀ (such as C₁ to C₃) hydrocarbon group, a heteroatom containing group having up to twenty (such as 1, 2 or 3) carbon atoms, silicon, germanium, tin, lead, or phosphorus (such as R¹ and R² are a C₂ to C₂₀ alkyl, aryl or substituted aryl group, such as a C₂ to C₂₀ (such as C₁ to C₃) linear, branched or cyclic alkyl group), R¹ and R² may also be interconnected to each other directly or bound to each other through other groups);
R³ may be absent or may be a hydrocarbon group, a hydrogen, a halogen, a heteroatom containing group (optionally R³ is absent, for example, if L is an oxygen, or a hydrogen, or a linear, cyclic, or branched alkyl group having 1 to 20 carbon atoms);
each R⁸, R⁹, R¹⁰, and R¹¹ is as described for R¹⁷, R¹⁸, R²⁰, and R²¹ above, alternately each R⁸, R⁹, R¹⁰, and R¹¹ is independently hydrogen, a C₁ to C₁₆ alkyl group, a heteroatom (such as halide), or a heteroatom containing group containing up to 16 carbon atoms (such as a C₁ to C₁₄ linear or branched alkyl group, such as a methyl, ethyl, propyl, or butyl group or an isomer thereof); and
each R¹² group is as described for R¹⁹ above, alternately each R¹² group is independently a C₃ to C₁₆ alkyl group, a substituted C₃ to C₁₆ alkyl group, a C₆ to C₁₆ aryl group, a substituted C₆ to C₁₆ aryl group.

In embodiments of Formula (X) or (XII) herein, M is Zr.

In embodiments of Formula (X) or (XII) herein, each X is, independently, selected from the group consisting of hydrocarbyl radicals having from 1 to 20 carbon atoms, hydrides, amides, alkoxides, sulfides, phosphides, halides, dienes, amines, phosphines, ethers, and a combination thereof, (two X's may form a part of a fused ring or a ring system), preferably each X is independently selected from halides and C₁ to C₅ alkyl groups, preferably each X is a methyl group.

Alternatively, each X of Formula (X) or (XII) herein is, independently, a halide, a hydride, an alkyl group, an alkenyl group or an arylalkyl group.

Alternatively, each X of Formula (X) or (XII) herein is, independently, selected from Cl, Br, F, I, methyl, ethyl, propyl, butyl, pentyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, phenyl, substituted phenyl (such as methylphenyl, dimethylphenyl, and biphenyl), benzyl, substituted benzyl (such as methylbenzyl), naphthyl, cyclohexyl, cyclohexenyl, methylcyclohexyl, and isomers thereof.

In embodiments of Formula (X) or (XII) herein, R¹ and R² are, independently, a C₁ to C₂₀ (such as C₁ to C₃) hydrocarbon group, a substituted hydrocarbon group, such as methyl, ethyl, propyl, butyl, pentyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, phenyl, substituted phenyl (such as methylphenyl, dimethylphenyl, and biphenyl), benzyl, substituted benzyl (such as methylbenzyl), naphthyl, cyclohexyl, cyclohexenyl, methylcyclohexyl, and isomers thereof.

In embodiments of Formula (X) or (XII) herein, R³ is absent.

In embodiments of Formula (X) or (XII) herein, R³ is selected from Cl, Br, F, I, methyl, ethyl, propyl, butyl, pentyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, phenyl, substituted phenyl (such as methylphenyl, dimethylphenyl, and biphenyl), benzyl, substituted benzyl (such as methylbenzyl), naphthyl, cyclohexyl, cyclohexenyl, methylcyclohexyl, and isomers thereof.

In embodiments of Formula (X), M is Zr.

In embodiments of Formula (X), at least one, two, three or all four of R¹⁷, R¹⁸, R²⁰, and R²¹ is not hydrogen.

In embodiments of Formula (X), at least one, two, three or all four of R¹⁷, R¹⁸, R²⁰, and R²¹ is selected from methyl, ethyl propyl, butyl, pentyl, and hexyl. Alternately R¹⁷ and R¹² are independently selected from methyl, ethyl propyl, butyl, pentyl, and hexyl, alternately both R¹⁷ and R²¹ are methyl.

Alternately in formula (X), and each R¹⁷, R¹⁸, R²⁰, and

R²¹ is hydrogen.

In embodiments of Formula (X), Y, Z, and L are is N.

In embodiments of Formula (X), Z is N or P, preferably N.

In embodiments of Formula (X), L is N or P, preferably N.

In embodiments of Formula (X), Y is N or P, preferably N.

In embodiments of Formula (X), each R⁴ and R⁵ is independently a substituted C₅ to C₂₂ aromatic group (such as a substituted aryl group (such as a substituted phenyl group, a substituted benzyl group, a substituted naphthyl group, or a substituted anthracenyl group)).

In embodiments of Formula (X), each R⁴ and R⁵ is independently a hydrocarbyl substituted phenyl group represented by the formula:

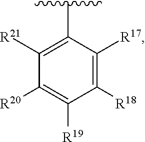

where each of R¹⁷, R¹⁸, R²⁰, and R²¹ is independently selected from hydrogen, C₁-C₄₀ hydrocarbyl or C₁-C₄₀ substituted hydrocarbyl, a heteroatom or a heteroatom-containing group, or two or more of R¹⁷, R¹⁸, R¹⁹, R²⁰, and R²¹ are joined together to form a C₄-C₆₂ cyclic or polycyclic ring structure, or a combination thereof.

Each R¹⁹ is independently selected from C₃-C₂₂ hydrocarbyl or C₁-C₂₂ substituted hydrocarbyl, a heteroatom or a heteroatom-containing group. Alternately, each R¹⁹ is independently one or more of C₃ to C₁₆ (such as C₆ to C₁₄, alternately C₈ to C₁₂) hydrocarbyl (such as C₃ to C₁₆ alkyl, such as linear or branched C₃ to C₁₆ alkyl, such as propyl, butyl, pentyl, hexyl, heptyl, octyl, nonyl, decyl, undecyl, dodecyl, tridecyl, tetradecyl, pentadecyl; hexadecyl, heptadecyl, phenyl, methylphenyl and dimethylphenyl, benzyl, methylbenzyl, naphthyl, cyclohexyl, cyclohexenyl, methylcyclohexyl or an isomer thereof. Alternately R¹⁹ is a linear alkyl selected from the group consisting of: propyl, butyl, pentyl, hexyl, heptyl, octyl, nonyl, decyl, undecyl, dodecyl, tridecyl, tetradecyl, pentadecyl, hexadecyl, and heptadecyl.

In embodiments of Formula (XII), M is Zr.

In embodiments of Formula (XII), at least one, two, three or all four of R⁸, R⁹, R¹⁰, and R¹¹ is not hydrogen.

In embodiments of Formula (XII), at least one, two, three or all four of R⁸, R⁹, R¹⁰, and R¹¹ is selected from methyl, ethyl propyl, butyl, pentyl, and hexyl.

Alternately in Formula (XII), and each R⁸, R⁹, R¹⁰, and R¹¹ is hydrogen.

Alternately R⁹ and R¹⁰ are independently selected from methyl, ethyl propyl, butyl, pentyl, and hexyl, alternately both R⁹ and R¹⁰ are methyl.

In embodiments of Formula (X) or (XII) herein, R⁸, R⁹, R¹⁰, and R¹¹ are methyl, and R¹⁹ is independently selected from C₃-C₂₂ hydrocarbyl or C₁-C₂₂ substituted hydrocarbyl (alternately C₆-C₂₂ hydrocarbyl or C₆-C₂₂ substituted hydrocarbyl).

In embodiments of Formula (X) or (XII) herein, R⁸, R⁹, R¹⁰, and R¹¹ are methyl, propyl, butyl or an isomer thereof, and R¹⁹ is independently selected from C₃-C₂₂ hydrocarbyl or C₁-C₂₂ substituted hydrocarbyl, (alternately C₆-C₂₂ hydrocarbyl or C₆-C₂₂ substituted hydrocarbyl).

Catalyst compounds useful herein include:

[N′-(2,3,5,6-tetramethyl-4-alkyl-phenyl)-N-[2-(2,3,5,6-tetramethyl-4-alkyl-phenyl)amino-κN]ethyl]-1,2-ethane-diaminato(2-)κN,κN′]MR₂, where M is Zr of Hf, each R is independently halogen or hydrocarbyl (such as cl, Br, F, I, methyl, ethyl, propyl, butyl, pentyl, hexyl, heptyl, octyl, nonyl, decyl, undecyl, dodecyl), and each alkyl is independently a C₈ to C₂₂ alkyl group (such as octyl, nonyl, decyl, undecyl, dodecyl, tridecyl, tetradecyl, pentadecyl, hexadecyl, and heptadecyl, octadecyl, nonadecyl, eicosyl, heneicosyl, and docosyl).

Catalyst compounds useful herein include: [N′-(2,3,5,6-tetramethyl-4-alkyl-phenyl)-N-[2-(2,3,5,6-tetramethyl-4-alkyl-phenyl)amino-κN]ethyl]-1,2-ethane-diaminato(2-)κN,κN′]zirconium dibenzyl, where each alkyl is independently a C₈ to C₂₂ alkyl group, such as octyl, nonyl, decyl, undecyl, dodecyl, tridecyl, tetradecyl, pentadecyl, hexadecyl, and heptadecyl, octadecyl, nonadecyl, eicosyl, heneicosyl, and docosyl.

Catalyst compounds useful herein include:
[N′-(2,3,5,6-tetramethyl-4-dodceyl-phenyl)-N-[2-(2,3,5,6-tetramethyl-4-dodecyl-phenyl)amino-κN]ethyl]-1,2-ethane-diaminato(2-)κN,κN′]zirconium dichloride;
[N′-(2,3,5,6-tetramethyl-4-decyl-phenyl)-N-[2-(2,3,5,6-tetramethyl-4-decyl-phenyl)amino-κN]ethyl]-1,2-ethane-diaminato(2-)κN,κN′]zirconium dichloride;
[N′-(2,3,5,6-tetramethyl-4-tetradecyl,-phenyl)-N-[2-(2,3,5,6-tetramethyl-4-tetradecyl,-phenyl)amino-κN]ethyl]-1,2-ethane-diaminato(2-)κN,κN′]zirconium dichloride;
[N′-(2,3,5,6-tetramethyl-4-hexadecyl,-phenyl)-N-[2-(2,3,5,6-tetramethyl-4-hexadecyl,-phenyl)amino-κN]ethyl]-1,2-ethane-diaminato(2-)κN,κN′]zirconium dichloride;
[N′-(2,3,5,6-tetramethyl-4-octadecyl,-phenyl)-N-[2-(2,3,5,6-tetramethyl-4-octadecyl,-phenyl)amino-κN]ethyl]-1,2-ethane-diaminato(2-)κN,κN′]zirconium dichloride;
[N′-(2,3,5,6-tetramethyl-4-eicosyl,-phenyl)-N-[2-(2,3,5,6-tetramethyl-4-eicosyl,-phenyl)amino-κN]ethyl]-1,2-ethane-diaminato(2-)κN,κN′]zirconium dichloride; and
[N′-(2,3,5,6-tetramethyl-4-docosyl,-phenyl)-N-[2-(2,3,5,6-tetramethyl-4-docosyl,-phenyl)amino-κN]ethyl]-1,2-ethane-diaminato(2-)κN,κN′]zirconium dichloride.

Catalyst compounds useful herein include:
[N′-(2,3,5,6-tetramethyl-4-dodceyl-phenyl)-N-[2-(2,3,5,6-tetramethyl-4-dodecyl-phenyl)amino-κN]ethyl]-1,2-ethane-diaminato(2-)κN,κN′]zirconium dichloride;
[N′-(2,3,5,6-tetramethyl-4-decyl-phenyl)-N-[2-(2,3,5,6-tetramethyl-4-decyl-phenyl)amino-κN]ethyl]-1,2-ethane-diaminato(2-)κN,κN]zirconium dichloride;
[N′-(2,3,5,6-tetramethyl-4-tetradecyl,-phenyl)-N-[2-(2,3,5,6-tetramethyl-4-tetradecyl,-phenyl)amino-κN]ethyl]-1,2-ethane-diaminato(2-)κN,κN′]zirconium dichloride;
[N′-(2,3,5,6-tetramethyl-4-hexadecyl,-phenyl)-N-[2-(2,3,5,6-tetramethyl-4-hexadecyl,-phenyl)amino-κN]ethyl]-1,2-ethane-diaminato(2-)κN,κN]zirconium dichloride;
[N′-(2,3,5,6-tetramethyl-4-octadecyl,-phenyl)-N-[2-(2,3,5,6-tetramethyl-4-octadecyl,-phenyl)amino-κN]ethyl]-1,2-ethane-diaminato(2-)κN,κN′]zirconium dichloride;
[N′-(2,3,5,6-tetramethyl-4-eicosyl,-phenyl)-N-[2-(2,3,5,6-tetramethyl-4-eicosyl,-phenyl)amino-κN]ethyl]-1,2-ethane-diaminato(2-)κN,κN]zirconium dichloride;
[N′-(2,3,5,6-tetramethyl-4-docosyl,-phenyl)-N-[2-(2,3,5,6-tetramethyl-4-docosyl,-phenyl)amino-κN]ethyl]-1,2-ethane-diaminato(2-)κN,κN′]zirconium dichloride;
[N′-(2,3,5,6-tetramethyl-4-dodceyl-phenyl)-N-[2-(2,3,5,6-tetramethyl-4-dodecyl-phenyl)amino-κN]ethyl]-1,2-ethane-diaminato(2-)κN,κN′]zirconium dibenzyl;
[N′-(2,3,5,6-tetramethyl-4-decyl-phenyl)-N-[2-(2,3,5,6-tetramethyl-4-decyl-phenyl)amino-κN]ethyl]-1,2-ethane-diaminato(2-)κN,κN′]zirconium dibenzyl; and
[N′-(4-decyl-phenyl)-N-[2-(4-decyl-phenyl)amino-κN]ethyl]-1,2-ethane-diaminato(2-) κN,κN′]zirconium dibenzyl.

Catalyst compounds useful herein include:

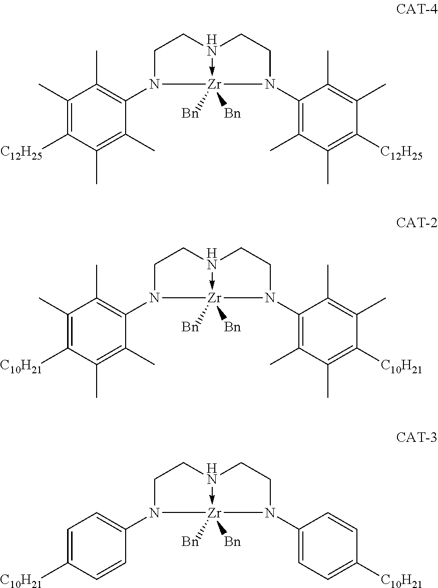

In useful embodiments of the invention, the catalyst compound is soluble in non-aromatic-hydrocarbon solvents, such as aliphatic solvents.

In one or more embodiments, a 20 wt % mixture of the catalyst compound in n-hexane, isohexane, cyclohexane, methylcyclohexane, or a combination thereof, forms a clear homogeneous solution at 25° C., preferably a 30 wt % mixture of the catalyst compound in n-hexane, isohexane, cyclohexane, methylcyclohexane, or a combination thereof, forms a clear homogeneous solution at 25° C.

In embodiments of the invention, the catalyst compounds described herein have a solubility of more than 10 mM (or more than 20 mM, or more than 50 mM) at 25° C. (stirred 2 hours) in methylcyclohexane.

In embodiments of the invention, the catalyst compounds described herein have a solubility of more than 1 mM (or more than 10 mM, or more than 20 mM) at 25° C. (stirred 2 hours) in isohexane.

In embodiments of the invention, the catalyst compounds described herein have a solubility of more than 10 mM (or more than 20 mM, or more than 50 mM) at 25° C. (stirred 2 hours) in methylcyclohexane and a solubility of more than 1 mM (or more than 10 mM, or more than 20 mM) at 25° C. (stirred 2 hours) in isohexane.

In a preferred embodiment, the catalyst compound is a non-aromatic-hydrocarbon (such as toluene) soluble catalyst compound.

In embodiments of the invention, aromatic solvents, such as toluene, are absent from the catalyst compounds, and compositions comprising the catalyst compounds, (e.g. present at zero mol %, alternately present at less than 1 mol %), preferably the catalyst compounds, and compositions comprising the catalyst compounds, are free of “detectable aromatic hydrocarbon solvent,” such as toluene. For purposes of the present disclosure, “detectable aromatic hydrocarbon solvent” means 0.1 mg/m² or more as determined by gas phase chromatography. For purposes of the present disclosure, “detectable toluene” means 0.1 mg/m² or more as determined by gas phase chromatography.

In a preferred embodiment in any of the processes described herein one catalyst compound is used, e.g. the catalyst compounds are not different. For purposes of this invention one catalyst compound is considered different from another if they differ by at least one atom. Catalyst compounds that differ only by isomer are considered the same for purposes if this invention.

In some embodiments, two or more different catalyst compounds are present in the catalyst system used herein. In some embodiments, two or more different catalyst compounds are present in the reaction zone where the process(es) described herein occur. The two or more catalyst compounds can be selected from compounds described here (e.g., Formulas (X) and (XII). Alternately the two or more compounds may comprise one or more single site coordination polymerization catalyst compounds not represented by Formula (X) or (XII) and at least one of the two or more catalyst compounds is represented by Formula (X) and/or (XII). It is convenient to use the same activator for the transition metal compounds, however, two different activators, such as a non-coordinating anion activator and an alumoxane, can be used in combination. If one or more transition metal compounds contain an X ligand which is not a hydride, hydrocarbyl, or substituted hydrocarbyl, then an alumoxane or aluminum alkyl is typically contacted with the transition metal compounds prior to or with addition of a non-coordinating anion activator.

The two transition metal compounds (pre-catalysts) may be used in any ratio. Preferred molar ratios of (A) transition metal compound to (B) transition metal compound fall within the range of (A:B) 1:1000 to 1000:1, alternatively 1:100 to 500:1, alternatively 1:10 to 200:1, alternatively 1:1 to 100:1, and alternatively 1:1 to 75:1, and alternatively 5:1 to 50:1. The particular ratio chosen will depend on the exact pre-catalysts chosen, the method of activation, and the end product desired. In a particular embodiment, when using the two pre-catalysts, where both are activated with the same activator, useful mole percents, based upon the molecular weight of the pre-catalysts, are 10 to 99.9% A to 0.1 to 90% B, alternatively 25 to 99% A to 0.5 to 50% B, alternatively 50 to 99% A to 1 to 25% B, and alternatively 75 to 99% A to 1 to 10% B.

Alternately, the catalyst compounds described herein may be used in combination with other single site coordination polymerization catalysts (such as metallocene catalyst compounds or post-metallocene catalyst compounds) to produce multi-modal (such as bi-modal) molecular weight polymer compositions. Useful metallocene catalyst compounds include:
(n-propyl cyclopentadienyl, tetramethyl cyclopentadienyl)zirconium dichloride,
(n-propyl cyclopentadienyl, tetramethyl cyclopentadienyl)zirconium dimethyl,
Bis(n-butylcyclopentadienyl)zirconium dichloride,
Bis(n-butylcyclopentadienyl)zirconium dimethyl,
Bis(1-methyl-3-n-butylcylopentadienyl)zirconium dichloride,
Bis(1-methyl-3-n-butylcylopentadienyl)zirconium dimethyl,
(n-propyl cyclopentadienyl, pentamethyl cyclopentadienyl)zirconium dichloride, and
(n-propyl cyclopentadienyl, pentamethyl cyclopentadienyl)zirconium dimethyl.

### Methods to Prepare the Catalyst Compounds.

Catalyst compounds described are synthesized by routes such as the following:

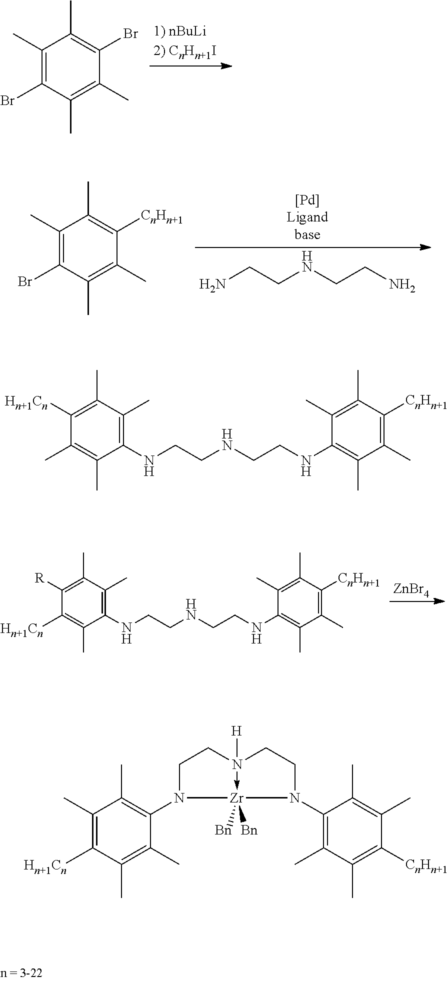

where n is 3 or more, such as 3 to 30, such as 4 to 20, such as 5 to 18, such as 6 to 16, such as 6 to 14, such as 6 to 12.

### Activators

The terms “cocatalyst” and “activator” are used herein interchangeably.

The catalyst systems described herein typically comprises a catalyst complex, such as the complexes described above, and an activator such as alumoxane or a non-coordinating anion containing activator. These catalyst systems may be formed by combining the catalyst components described herein with activators in any manner known from the literature. The catalyst systems may also be added to or generated in solution polymerization or bulk polymerization (in the monomer). Catalyst systems of the present disclosure may have one or more activators and one, two or more catalyst components. Activators are defined to be any compound which can activate any one of the catalyst compounds described above by converting the neutral metal compound to a catalytically active metal compound cation. Non-limiting activators, for example, include alumoxanes, ionizing activators, which may be neutral or ionic, and conventional-type cocatalysts. Preferred activators typically include alumoxane compounds, modified alumoxane compounds, and ionizing anion precursor compounds that abstract a reactive metal ligand making the metal compound cationic and providing a charge-balancing non-coordinating or weakly coordinating anion, e.g. a non-coordinating anion.

### Alumoxane Activators

Alumoxane activators can be utilized as activators in the catalyst systems described herein. Alumoxanes are generally oligomeric compounds containing —Al(R¹)—O— sub-units, where R¹ is an alkyl group. Examples of alumoxanes include methylalumoxane (MAO), modified methylalumoxane (MMAO), ethylalumoxane and isobutylalumoxane.

Alkylalumoxanes and modified alkylalumoxanes are suitable as catalyst activators, particularly when the abstractable ligand is an alkyl, halide, alkoxide or amide. Mixtures of different alumoxanes and modified alumoxanes may also be used. It may be preferable to use a visually clear methylalumoxane. A cloudy or gelled alumoxane can be filtered to produce a clear solution or clear alumoxane can be decanted from the cloudy solution. A useful alumoxane is a modified methyl alumoxane (MMAO) suhc as those described in U.S. Pat. No. 5,041,584. Another useful alumoxane is solid polymethylaluminoxane as described in U.S. Pat. Nos. 9,340,630; 8,404,880; and 8,975,209.

When the activator is an alumoxane (modified or unmodified), typically the maximum amount of activator is at up to a 5,000-fold molar excess Al/M over the catalyst compound (per metal catalytic site). The minimum activator-to-catalyst-compound is a 1:1 molar ratio. Alternate preferred ranges include from 1:1 to 500:1, alternately from 1:1 to 200:1, alternately from 1:1 to 100:1, or alternately from 1:1 to 50:1.

In embodiments, the activators described in US 2019/0127497 may be used with the catalyst compounds described herein.

In an alternate embodiment, little or no alumoxane is used in the polymerization processes described herein. Preferably, alumoxane is present at zero mole %, alternately the alumoxane is present at a molar ratio of aluminum to catalyst compound transition metal less than 500:1, preferably less than 300:1, preferably less than 100:1, preferably less than 1:1.

### Ionizing/Non Coordinating Anion Activators

The term “non-coordinating anion” (NCA) means an anion which either does not coordinate to a cation or which is only weakly coordinated to a cation thereby remaining sufficiently labile to be displaced, typically by a neutral Lewis base. Further, the anion will not transfer an anionic substituent or fragment to the cation so as to cause it to form a neutral transition metal compound and a neutral by-product from the anion. Non-coordinating anions useful in accordance with this invention are those that are compatible, stabilize the transition metal cation in the sense of balancing its ionic charge at +1, and yet retain sufficient lability to permit displacement during polymerization. The term NCA is also defined to include multicomponent NCA-containing activators, such as N,N-dimethylanilinium tetrakis(pentafluorophenyl)borate, that contain an acidic cationic group and the non-coordinating anion. The term NCA is also defined to include neutral Lewis acids, such as tris(pentafluorophenyl)boron, that can react with a catalyst to form an activated species by abstraction of an anionic group. Any metal or metalloid that can form a compatible, weakly coordinating complex may be used or contained in the non-coordinating anion. Suitable metals include, but are not limited to, aluminum, gold, and platinum. Suitable metalloids include, but are not limited to, boron, aluminum, phosphorus, and silicon.

It is within the scope of this invention to use an ionizing activator, neutral or ionic. It is also within the scope of this invention to use neutral or ionic activators alone or in combination with alumoxane or modified alumoxane activators.

In embodiments of the invention, the activator is represented by the Formula (III):

(Z)_{d}⁺(A^{d-}) (III)

wherein Z is (L-H) or a reducible Lewis Acid, L is an neutral Lewis base; H is hydrogen; (L-H)⁺ is a Bronsted acid; A^{d-} is a non-coordinating anion having the charge d−; and d is an integer from 1 to 3 (such as 1, 2 or 3).

The anion component A^{d-} includes those having the formula [M^{k+}Qₙ]^{d-} wherein k is 1, 2, or 3; n is 1, 2, 3, 4, 5, or 6 (preferably 1, 2, 3, or 4); n−k=d; M is an element selected from Group 13 of the Periodic Table of the Elements, preferably boron or aluminum, and Q is independently a hydride, bridged or unbridged dialkylamido, halide, alkoxide, aryloxide, hydrocarbyl, substituted hydrocarbyl, halocarbyl, substituted halocarbyl, and halosubstituted-hydrocarbyl radicals, said Q having up to 40 carbon atoms (optionally with the proviso that in not more than 1 occurrence is Q a halide). Preferably, each Q is a fluorinated hydrocarbyl group having 1 to 40 (such as 1 to 30, such as 1 to 20) carbon atoms, more preferably each Q is a fluorinated aryl group, such as a perfluorinated aryl group and most preferably each Q is a pentafluoryl aryl group or perfluoronaphthalenyl group. Examples of suitable A^{d-} also include diboron compounds as disclosed in U.S. Pat. No. 5,447,895, which is fully incorporated herein by reference.

When Z is the activating cation (L-H), it can be a Bronsted acid, capable of donating a proton to the transition metal catalytic precursor resulting in a transition metal cation, including ammoniums, oxoniums, phosphoniums, sulfoniums, and mixtures thereof, such as ammoniums of methylamine, aniline, dimethylamine, diethylamine, N-methylaniline, N-methyl-4-nonadecyl-N-octadecylaniline, N-methyl-4-octadecyl-N-octadecylaniline, diphenylamine, trimethylamine, triethylamine, N,N-dimethylaniline, methyldiphenylamine, pyridine, p-bromo N,N-dimethylaniline, p-nitro-N,N-dimethylaniline, dioctadecylmethylamine, phosphoniums from triethylphosphine, triphenylphosphine, and diphenylphosphine, oxoniums from ethers such as dimethyl ether, diethyl ether, tetrahydrofuran and dioxane, sulfoniums from thioethers, such as diethyl thioethers, tetrahydrothiophene, and mixtures thereof. In one embodiment, the borate activator comprises tetrakis(heptafluoronaphth-2-yl)borate and or tetrakis(pentafluorophenyl)borate.

Optionally, Z is (Ar₃C⁺), where Ar is aryl or aryl substituted with a heteroatom, a C₁ to C₄₀ hydrocarbyl, or a substituted C₁ to C₄₀ hydrocarbyl.

Alternately (Z)_{d}⁺ is represented by the formula:

[R¹′R²′R³′EF]_{d}⁺

wherein E is nitrogen or phosphorous: d is 1, 2 or 3; R¹′, R²′, and R³′ are independently hydrogen or a C₁ to C₅₀ hydrocarbyl group optionally substituted with one or more alkoxy groups, silyl groups, a halogen atoms, or halogen containing groups, wherein R¹′, R²′, and R³′ together comprise 15 or more carbon atoms.

Alternately E is nitrogen; R¹′ is hydrogen, and R²′, and R³′ are independently a C₆-C₄₀ hydrocarbyl group optionally substituted with one or more alkoxy groups, silyl groups, a halogen atoms, or halogen containing groups, wherein R²′, and R³′ together comprise 14 or more carbon atoms.

Alternately E is nitrogen; R¹′ is hydrogen, and R²′ is a C₆-C₄₀ hydrocarbyl group optionally substituted with one or more alkoxy groups, silyl groups, a halogen atoms, or halogen containing groups, and R³′ is a substituted phenyl group, wherein R²′, and R³′ together comprise 14 or more carbon atoms.

Alternately, (Z)_{d}⁺ is represented by the formula:

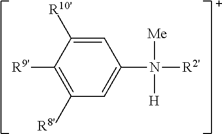

wherein N is nitrogen, H is hydrogen, Me is methyl, R²′ is a C₆-C₄₀ hydrocarbyl group optionally substituted with one or more alkoxy groups, silyl groups, a halogen atoms, or halogen containing groups; R⁸′, R⁹′, and R¹⁰′ are independently a C₄-C₃₀ hydrocarbyl or substituted C₄-C₃₀ hydrocarbyl group.

Optionally, R⁸′ and R¹⁰′ are hydrogen atoms and R⁹′ is a C₄-C₃₀ hydrocarbyl group which is optionally substituted with one or more alkoxy groups, silyl groups, a halogen atoms, or halogen containing groups.

Optionally, R⁹′ is a C₈-C₂₂ hydrocarbyl group which is optionally substituted with one or more alkoxy groups, silyl groups, a halogen atoms, or halogen containing groups.

Optionally, R²′ and R³′ are independently a C₁₂-C₂₂ hydrocarbyl group.

Optionally, R¹′, R²′ and R³′ together comprise 15 or more carbon atoms (such as 18 or more carbon atoms, such as 20 or more carbon atoms, such as 22 or more carbon atoms, such as 25 or more carbon atoms, such as 30 or more carbon atoms, such as 35 or more carbon atoms, such as 38 or more carbon atoms, such as 40 or more carbon atoms, such as 15 to 100 carbon atoms, such as 25 to 75 carbon atoms).

Optionally, R²′ and R³′ together comprise 15 or more carbon atoms (such as 18 or more carbon atoms, such as 20 or more carbon atoms, such as 22 or more carbon atoms, such as 25 or more carbon atoms, such as 30 or more carbon atoms, such as 35 or more carbon atoms, such as 38 or more carbon atoms, such as 40 or more carbon atoms, such as 15 to 100 carbon atoms, such as 25 to 75 carbon atoms).

Optionally, R⁸′, R⁹′, and R¹⁰′ together comprise 15 or more carbon atoms (such as 18 or more carbon atoms, such as 20 or more carbon atoms, such as 22 or more carbon atoms, such as 25 or more carbon atoms, such as 30 or more carbon atoms, such as 35 or more carbon atoms, such as 38 or more carbon atoms, such as 40 or more carbon atoms, such as 15 to 100 carbon atoms, such as 25 to 75 carbon atoms).

Optionally, when Q in the formula [M^{k}+Qₙ]^{d-} is a fluorophenyl group, then R²′ is not a C₁-C₄₀ linear alkyl group (alternately R²′ is not an optionally substituted C₁-C₄₀ linear alkyl group).

Optionally, each Q in the formula [M^{k+}Qₙ]^{d-} is an aryl group (such as phenyl or naphthalenyl), wherein at least one Q is substituted with at least one fluorine atom, preferably each Q is a perfluoroaryl group (such as perfluorophenyl or perfluoronaphthalenyl).

Optionally, R¹′ is a methyl group; R²′ is C₆-C₅₀ aryl group; and R³′ is independently C₁-C₄₀ linear alkyl or C₅-C₅₀-aryl group.

Optionally, each of R²′ and R³′ is independently unsubstituted or substituted with at least one of halide, C₁-C₃₅ alkyl, C₅-C₁₅ aryl, C₆-C₃₅ arylakl, C₆-C₃₅ alkylaryl, wherein R², and R³ together comprise 20 or more carbon atoms.

Optionally, each Q is independently a hydride, bridged or unbridged dialkylamido, halide, alkoxide, aryloxide, hydrocarbyl, substituted hydrocarbyl, halocarbyl, substituted halocarbyl, or halosubstituted-hydrocarbyl radical, provided that when Q is a fluorophenyl group, then R²′ is not a C₁-C₄₀ linear alkyl group, preferably R²′ is not an optionally substituted C₁-C₄₀ linear alkyl group (alternately when Q is a substituted phenyl group, then R²′ is not a C₁-C₄₀ linear alkyl group, preferably R²′ is not an optionally substituted C₁-C₄₀ linear alkyl group). Optionally, when Q is a fluorophenyl group (alternately when Q is a substituted phenyl group), then R²′ is a meta- and/or para-substituted phenyl group, where the meta and para substituents are, independently, an optionally substituted C₁ to C₄₀ hydrocarbyl group (such as a C₆ to C₄₀ aryl group or linear alkyl group, a C₁₂ to C₃₀ aryl group or linear alkyl group, or a C₁₀ to C₂₀ aryl group or linear alkyl group), an optionally substituted alkoxy group, or an optionally substituted silyl group. Optionally, each Q is a fluorinated hydrocarbyl group having 1 to 30 carbon atoms, more preferably each Q is a fluorinated aryl (such as phenyl or naphthalenyl) group, and most preferably each Q is a perfluorinated aryl (such as phenyl or naphthalenyl) group. Examples of suitable [Mt^{k+}Qₙ]^{d-} also include diboron compounds as disclosed in U.S. Pat. No. 5,447,895, which is fully incorporated herein by reference. Optionally, at least one Q is not substituted phenyl. Optionally all Q are not substituted phenyl. Optionally at least one Q is not perfluorophenyl. Optionally all Q are not perfluorophenyl.

Useful cation components (Z)_{d}⁺ include those represented by the formulas:

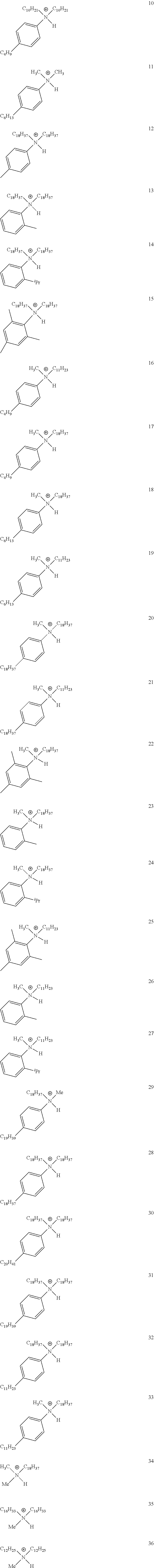

Useful cation components in (Z)_{d}⁺ include those represented by the formulas:

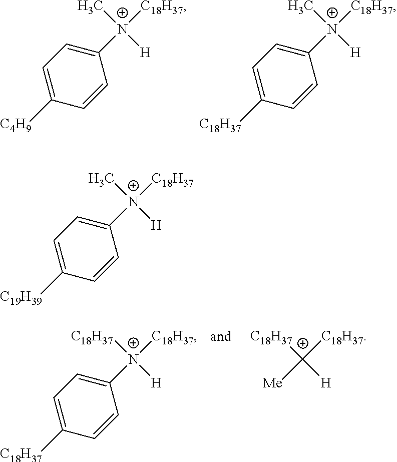

Anions for use in the non-coordinating anion activators described herein also include those represented by Formula 7, below:

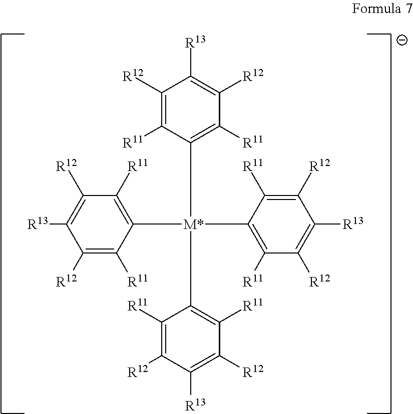

wherein:
M* is a group 13 atom, preferably B or Al, preferably B;
each R¹¹ is, independently, a halide, preferably a fluoride;
each R¹² is, independently, a halide, a C₆ to C₂₀ substituted aromatic hydrocarbyl group or a siloxy group of the formula —O—Si—R^{a}, where R^{a} is a C₁ to C₂₀ hydrocarbyl or hydrocarbylsilyl group, preferably R¹² is a fluoride or a perfluorinated phenyl group;
each R¹³ is a halide, a C₆ to C₂₀ substituted aromatic hydrocarbyl group or a siloxy group of the formula —O—Si—R^{a}, where R^{a} is a C₁ to C₂₀ hydrocarbyl or hydrocarbylsilyl group, preferably R¹³ is a fluoride or a C₆ perfluorinated aromatic hydrocarbyl group;
wherein R¹² and R¹³ can form one or more saturated or unsaturated, substituted or unsubstituted rings, preferably R¹² and R¹³ form a perfluorinated phenyl ring. Preferably the anion has a molecular weight of greater than 700 g/mol, and, preferably, at least three of the substituents on the M* atom each have a molecular volume of greater than 180 cubic Å.

“Molecular volume” is used herein as an approximation of spatial steric bulk of an activator molecule in solution. Comparison of substituents with differing molecular volumes allows the substituent with the smaller molecular volume to be considered “less bulky” in comparison to the substituent with the larger molecular volume. Conversely, a substituent with a larger molecular volume may be considered “more bulky” than a substituent with a smaller molecular volume.

Molecular volume may be calculated as reported in “A Simple “Back of the Envelope” Method for Estimating the Densities and Molecular Volumes of Liquids and Solids,” Journal of Chemical Education, v.71(11), November 1994, pp. 962-964. Molecular volume (MV), in units of cubic Å, is calculated using the formula: MV=8.3V_{S}, where V_{S} is the scaled volume. V_{S} is the sum of the relative volumes of the constituent atoms, and is calculated from the molecular formula of the substituent using Table A below of relative volumes. For fused rings, the V_{S} is decreased by 7.5% per fused ring. The Calculated Total MV of the anion is the sum of the MV per substituent, for example, the MV of perfluorophenyl is 183 Å³, and the Calculated Total MV for tetrakis(perfluorophenyl)borate is four times 183 Å³, or 732 Å³.

TABLE A

| Element | Relative Volume |
|---|---|
| H | 1 |
| 1^{st} short period, Li to F | 2 |
| 2^{nd} short period, Na to Cl | 4 |
| 1^{st} long period, K to Br | 5 |
| 2^{nd} long period, Rb to I | 7.5 |
| 3^{rd} long period, Cs to Bi | 9 |

Exemplary anions useful herein and their respective scaled volumes and molecular volumes are shown in Table B below. The dashed bonds indicate bonding to boron.

TABLE B

| | | Molecular | | MV | |
|---|---|---|---|---|---|
| | | Formula of | | Per | Calculated |
| | | Each | | subst. | Total MV |
| Ion | Structure of Boron Substituents | Substituent | V_{S} | (Å³) | (Å³) |
| tetrakis(perfluorophenyl)borate | 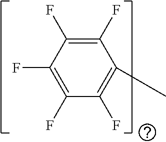 | C₆F₅ | 22 | 183 | 732 |
| tris(perfluorophenyl)- (perfluoronaphthalenyl)borate | 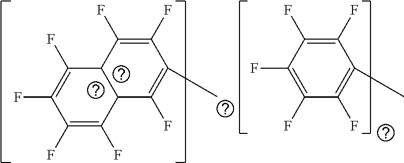 | C₆H₅ C₁₀F₇ | 22 34 | 183 261 | 810 |
| (perfluorophenyl)tris- (perfluoronaphthalenyl)borate | 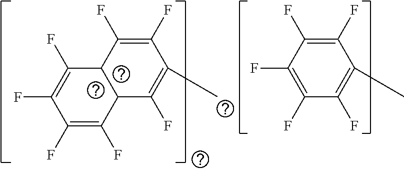 | C₆H₅ C₁₀F₇ | 22 34 | 183 261 | 966 |
| tetrakis(perfluoronaphthalenyl)bo- rate | 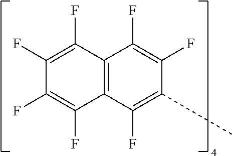 | C₁₀F₇ | 34 | 261 | 1044 |
| tetrakis(perfluorobiphenyl)borate | 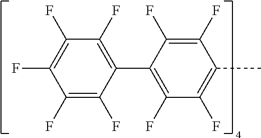 | C₁₂F₉ | 42 | 349 | 1396 |
| [(C₆F₃(C₆F₅)₂)₄B] | 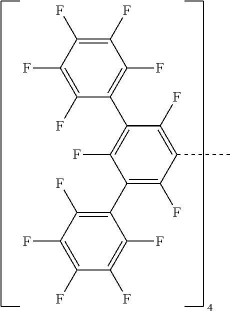 | C₁₈F₁₃ | 62 | 515 | 2060 |

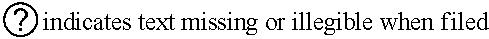

The activators may be added to a polymerization in the form of an ion pair using, for example, [M2HTH]+[NCA]− in which the di(hydrogenated tallow)methylamine (“M2HTH”) cation reacts with a basic leaving group on the transition metal complex to form a transition metal complex cation and [NCA]-. Alternatively, the transition metal complex may be reacted with a neutral NCA precursor, such as B(C₆F₅)₃, which abstracts an anionic group from the complex to form an activated species.

Activator compounds that useful in this invention include one or more of:
N-methyl-4-nonadecyl-N-octadecylanilinium tetrakis(perfluoronaphthalen-2-yl)borate,
N-methyl-4-nonadecyl-N-octadecylanilinium tetrakis(perfluorophenyl)borate,
dioctadecylmethylammonium tetrakis(pentafluorophenyl)borate,
dioctadecylmethylammonium tetrakis(perfluoronaphthyl)borate,
di(hydrogenated tallow)methylammonium[tetrakis(pentalluorophenyOborate],
N,N-dimethylanilinium [tetrakis(heptafluoronaphth-2-yl)borate],
N,N-dimethylanilinium [tetrakis(pentafluorophenyl)borate],
N,N-di(hydrogenated tallow)methylammonium [tetrakis(perfluorophenyl) borate],
N-methyl-4-nonadecyl-N-octadecylanilinium [tetrakis(perfluorophenyl)borate],
N-methyl-4-hexadecyl-N-octadecylanilinium [tetrakis(perfluorophenyl)borate],
N-methyl-4-tetradecyl-N-octadecylanilinium [tetrakis(perfluorophenyl)borate],
N-methyl-4-dodecyl-N-octadecylanilinium [tetrakis(perfluorophenyl)borate],
N-methyl-4-decyl-N-octadecylanilinium [tetrakis(perfluorophenyl)borate],
N-methyl-4-octyl-N-octadecylanilinium [tetrakis(perfluorophenyl)borate],
N-methyl-4-hexyl-N-octadecylanilinium [tetrakis(perfluorophenyl)borate],
N-methyl-4-butyl-N-octadecylanilinium [tetrakis(perfluorophenyl)borate],
N-methyl-4-octadecyl-N-decylanilinium [tetrakis(perfluorophenyl)borate],
N-methyl-4-nonadecyl-N-dodecylanilinium [tetrakis(perfluorophenyl)borate],
N-methyl-4-nonadecyl-N-tetradecylanilinium [tetrakis(perfluorophenyl)borate],
N-methyl-4-nonadecyl-N-hexadecylanilinium [tetrakis(perfluorophenyl)borate],
N-ethyl-4-nonadecyl-N-octadecylanilinium [tetrakis(perfluorophenyl)borate],
N-methyl-N,N-dioctadecylammonium [tetrakis(perfluorophenyl)borate],
N-methyl-N,N-dihexadecylammonium [tetrakis(perfluorophenyl)borate],
N-methyl-N,N-ditetradecylammonium [tetrakis(perfluorophenyl)borate],
N-methyl-N,N-didodecylammonium [tetrakis(perfluorophenyl)borate],
N-methyl-N,N-didecylammonium [tetrakis(perfluorophenyl)borate],
N-methyl-N,N-dioctylammonium [tetrakis(perfluorophenyl)borate],
N-ethyl-N,N-dioctadecylammonium [tetrakis(perfluorophenyl)borate],
N,N-di(octadecyl)tolylammonium [tetrakis(perfluorophenyl)borate],
N,N-di(hexadecyl)tolylammonium [tetrakis(perfluorophenyl)borate],
N,N-di(tetradecyl)tolylammonium [tetrakis(perfluorophenyl)borate],
N,N-di(dodecyl)tolylammonium [tetrakis(perfluorophenyl)borate],
N-octadecyl-N-hexadecyl-tolylammonium [tetrakis(perfluorophenyl)borate],
N-octadecyl-N-hexadecyl-tolylammonium [tetrakis(perfluorophenyl)borate],
N-octadecyl-N-tetradecyl-tolylammonium [tetrakis(perfluorophenyl)borate],
N-octadecyl-N-dodecyl-tolylammonium [tetrakis(perfluorophenyl)borate],
N-octadecyl-N-decyl-tolylammonium [tetrakis(perfluorophenyl)borate],
N-hexadecyl-N-tetradecyl-tolylammonium [tetrakis(perfluorophenyl)borate],
N-hexadecyl-N-dodecyl-tolylammonium [tetrakis(perfluorophenyl)borate],
N-hexadecyl-N-decyl-tolylammonium [tetrakis(perfluorophenyl)borate],
N-tetradecyl-N-dodecyl-tolylammonium [tetrakis(perfluorophenyl)borate],
N-tetradecyl-N-decyl-tolylammonium [tetrakis(perfluorophenyl)borate],
N-dodecyl-N-decyl-tolylammonium [tetrakis(perfluorophenyl)borate],
N-methyl-N-octadecylanilinium [tetrakis(perfluorophenyl)borate],
N-methyl-N-hexadecylanilinium [tetrakis(perfluorophenyl)borate],
N-methyl-N-tetradecylanilinium [tetrakis(perfluorophenyl)borate],
N-methyl-N-dodecylanilinium [tetrakis(perfluorophenyl)borate],
N-methyl-N-decylanilinium [tetrakis(perfluorophenyl)borate], and
N-methyl-N-octylanilinium [tetrakis(perfluorophenyl)borate].
Preferred activators for use herein also include:
N-methyl-4-nonadecyl-N-octadecylbenzenaminium tetrakis(pentafluorophenyl)borate,
N-methyl-4-nonadecyl-N-octadecylbenzenaminium tetrakis(perfluoronaphthalenyl)borate,
N,N-dimethylanilinium tetrakis(perfluoronaphthalenyl)borate,
N,N-dimethylanilinium tetrakis(perfluorobiphenyl)borate,
N,N-dimethylanilinium tetrakis(perfluorophenyl)borate,
N,N-dimethylanilinium tetrakis(3,5-bis(trifluoromethyl)phenyl)borate,
triphenylcarbenium tetrakis(perfluoronaphthalenyl)borate,
triphenylcarbenium tetrakis(perfluorobiphenyl)borate,
triphenylcarbenium tetrakis(3,5-bis(trifluoromethyl)phenyl)borate,
triphenylcarbenium tetrakis(perfluorophenyl)borate,
[Me₃NH^{+][B(C}₆F₅)₄⁻];
1-(4-(tris(pentafluorophenyl)borate)-2,3,5,6-tetrafluorophenyl)pyrrolidinium; and tetrakis(pentafluorophenyl)borate, 4-(tris(pentafluorophenyl)borate)-2,3,5,6-tetrafluoropyridine.

In a preferred embodiment, the activator comprises a triaryl carbenium (such as triphenylcarbenium tetraphenylborate, triphenylcarbenium tetrakis(pentafluorophenyl)borate, triphenylcarbenium tetrakis-(2,3,4,6-tetrafluorophenyl)borate, triphenylcarbenium tetrakis(perfluoronaphthalenyl)borate, triphenylcarbenium tetrakis(perfluorobiphenyl)borate, triphenylcarbenium tetrakis(3,5-bis(trifluoromethyl)phenyl)borate).

In another embodiment, the activator comprises one or more of trialkylammonium tetrakis(pentafluorophenyl)borate, N,N-dialkylanilinium tetrakis(pentafluorophenyl)borate, dioctadecylmethylammonium tetrakis(pentafluorophenyl)borate, dioctadecylmethylammonium tetrakis(perfluoronaphthalenyl)borate, N,N-dimethyl-(2,4,6-trimethylanilinium) tetrakis(pentafluorophenyl)borate, trialkylammonium tetrakis-(2,3,4,6-tetrafluorophenyl) borate, N,N-dialkylanilinium tetrakis-(2,3,4,6-tetrafluorophenyl)borate, trialkylammonium tetrakis (perfluoronaphthalenyl)borate, N,N-dialkylanilinium tetrakis(perfluoronaphthalenyl)borate, trialkylammonium tetrakis(perfluorobiphenyl)borate, N,N-dialkylanilinium tetrakis (perfluorobiphenyl)borate, trialkyl ammonium tetrakis(3,5-bis(trifluoromethyl)phenyl)borate, N,N-dialkylanilinium tetrakis(3,5-bis(trifluoromethyl)phenyl)borate, N,N-dialkyl-(2,4,6-trimethylanilinium) tetrakis(3,5-bis(trifluoromethyl)phenyl)borate, di-(i-propyl)ammonium tetrakis(pentafluorophenyl)borate, (where alkyl is methyl, ethyl, propyl, n-butyl, sec-butyl, or t-butyl).

Likewise, useful activators also include N,N-dimethylanilinium tetrakis(pentafluorophenyl)borate, N,N-dimethylanilinium tetrakis(heptafluoro-2-naphthalenyl)borate, dioctadecylmethylammonium tetrakis(pentafluorophenyl)borate, and dioctadecylmethylammonium tetrakis(perfluoronaphthyl)borate.

Additional useful activators and the synthesis of non-aromatic-hydrocarbon soluble activators are described in U.S. Ser. No. 16/394,166 filed Apr. 25, 2019, U.S. Ser. No. 16/394,186, filed Apr. 25, 2019, and U.S. Ser. No. 16/394,197, filed Apr. 25, 2019, which are incorporated by reference herein.

For a more detailed description of useful activators please see WO2004/026921 page 72, paragraph to page 81 paragraph [00151]; U.S. Pat. Nos. 8,658,556; 6,211,105; US 2019/0330139; and US 2019/0330392. A list of useful activators that can be used in the practice of this invention may be found at page 72, paragraph to page 74, paragraph of WO2004/046214.

The typical activator-to-catalyst ratio, e.g., all NCA activators-to-catalyst ratio is about a 1:1 molar ratio. Alternate preferred ranges include from 0.1:1 to 100:1, alternately from 0.5:1 to 200:1, alternately from 1:1 to 500:1 alternately from 1:1 to 1000:1. A particularly useful range is from 0.5:1 to 10:1, preferably 1:1 to 5:1.

It is also within the scope of the present disclosure that the catalyst compounds can be combined with combinations of alumoxanes and NCA's (see for example, U.S. Pat. Nos. 5,153,157; 5,453,410; EP 0 573 120 B1; WO1994/007928; and WO1995/014044 (the disclosures of which are incorporated herein by reference in their entirety) which discuss the use of an alumoxane in combination with an ionizing activator).

In useful embodiments of the invention, the activator is soluble in non-aromatic-hydrocarbon solvents, such as aliphatic solvents.

In one or more embodiments, a 20 wt % mixture of the activator compound in n-hexane, isohexane, cyclohexane, methylcyclohexane, or a combination thereof, forms a clear homogeneous solution at 25° C., preferably a 30 wt % mixture of the activator compound in n-hexane, isohexane, cyclohexane, methylcyclohexane, or a combination thereof, forms a clear homogeneous solution at 25° C.

In embodiments of the invention, the activators described herein have a solubility of more than 10 mM (or more than 20 mM, or more than 50 mM) at 25° C. (stirred 2 hours) in methylcyclohexane.

In embodiments of the invention, the activators described herein have a solubility of more than 1 mM (or more than 10 mM, or more than 20 mM) at 25° C. (stirred 2 hours) in isohexane.

In embodiments of the invention, the activators described herein have a solubility of more than 10 mM (or more than 20 mM, or more than 50 mM) at 25° C. (stirred 2 hours) in methylcyclohexane and a solubility of more than 1 mM (or more than 10 mM, or more than 20 mM) at 25° C. (stirred 2 hours) in isohexane.

In a preferred embodiment, the activator is a non-aromatic-hydrocarbon (such as toluene) soluble activator compound.

### Optional Scavengers, Co-Activators, Chain Transfer Agents

In addition to activator compounds, scavengers or co-activators may be used.

A scavenger is a compound that is typically added to facilitate polymerization by scavenging impurities. Some scavengers may also act as activators and may be referred to as co-activators. A co-activator, that is not a scavenger, may also be used in conjunction with an activator in order to form an active catalyst. In some embodiments a co-activator can be pre-mixed with the transition metal compound to form an alkylated transition metal compound. Aluminum alkyl or organoaluminum compounds which may be utilized as scavengers or co-activators include, for example, trimethylaluminum, triethylaluminum, triisobutylaluminum, tri-n-hexylaluminum, tri-n-octylaluminum, and diethyl zinc.

Chain transfer agents may be used in the compositions and or processes described herein. Useful chain transfer agents are typically alkylalumoxanes, a compound represented by the formula AlR₃, ZnR₂ (where each R is, independently, a C₁-C₈ aliphatic radical, preferably methyl, ethyl, propyl, butyl, penyl, hexyl octyl or an isomer thereof) or a combination thereof, such as diethyl zinc, methylalumoxane, trimethylaluminum, triisobutylaluminum, trioctylaluminum, or a combination thereof.

### Optional Support Materials

In embodiments herein, the catalyst system may comprise an inert support material. Preferably the supported material is a porous support material, for example, talc, and inorganic oxides. Other support materials include zeolites, clays, organoclays, or any other organic or inorganic support material and the like, or mixtures thereof.

Preferably, the support material is an inorganic oxide in a finely divided form. Suitable inorganic oxide materials for use in catalyst systems herein include Groups 2, 4, 13, and 14 metal oxides, such as silica, alumina, and mixtures thereof. Other inorganic oxides that may be employed either alone or in combination with the silica, or alumina are magnesia, titania, zirconia, and the like. Other suitable support materials, however, can be employed, for example, finely divided functionalized polyolefins, such as finely divided polyethylene. Particularly useful supports include magnesia, titania, zirconia, montmorillonite, phyllosilicate, zeolites, talc, clays, and the like. Also, combinations of these support materials may be used, for example, silica-chromium, silica-alumina, silica-titania, and the like. Preferred support materials include Al₂O₃, ZrO₂, SiO₂, and combinations thereof, more preferably SiO₂, Al₂O₃, or SiO₂/Al₂O₃.

It is preferred that the support material, most preferably an inorganic oxide, has a surface area in the range of from about 10 to about 700 m²/g, pore volume in the range of from about 0.1 to about 4.0 cc/g and average particle size in the range of from about 5 to about 500 μm. More preferably, the surface area of the support material is in the range of from about 50 to about 500 m²/g, pore volume of from about 0.5 to about 3.5 cc/g and average particle size of from about 10 to about 200 μm. Most preferably the surface area of the support material is in the range is from about 100 to about 400 m²/g, pore volume from about 0.8 to about 3.0 cc/g and average particle size is from about 5 to about 100 μm. The average pore size of the support material useful in the invention is in the range of from 10 to 1000 Å, preferably 50 to about 500 Å, and most preferably 75 to about 350 Å. In some embodiments, the support material is a high surface area, amorphous silica (surface area=300 m²/gm; pore volume of 1.65 cm³/gm). Preferred silicas are marketed under the tradenames of DAVISON™ 952 or DAVISON™ 955 by the Davison Chemical Division of W.R. Grace and Company. In other embodiments DAVISON™ 948 is used.

The support material should be dry, that is, free of absorbed water. Drying of the support material can be effected by heating or calcining at about 100° C. to about 1,000° C., preferably at least about 600° C. When the support material is silica, it is heated to at least 200° C., preferably about 200° C. to about 850° C., and most preferably at about 600° C.; and for a time of about 1 minute to about 100 hours, from about 12 hours to about 72 hours, or from about 24 hours to about 60 hours. The calcined support material must have at least some reactive hydroxyl (OH) groups to produce supported catalyst systems of this invention. The calcined support material is then contacted with at least one polymerization catalyst comprising at least one catalyst compound and an activator.

The support material, having reactive surface groups, typically hydroxyl groups, is slurried in a non-polar solvent and the resulting slurry is contacted with a solution of a catalyst compound and an activator. In some embodiments, the slurry of the support material is first contacted with the activator for a period of time in the range of from about 0.5 hours to about 24 hours, from about 2 hours to about 16 hours, or from about 4 hours to about 8 hours. The solution of the catalyst compound is then contacted with the isolated support/activator. In some embodiments, the supported catalyst system is generated in situ. In alternate embodiment, the slurry of the support material is first contacted with the catalyst compound for a period of time in the range of from about 0.5 hours to about 24 hours, from about 2 hours to about 16 hours, or from about 4 hours to about 8 hours. The slurry of the supported catalyst compound is then contacted with the activator solution.

The mixture of the catalyst, activator and support is heated to about 0° C. to about preferably to about 23° C. to about 60° C., preferably at room temperature. Contact times typically range from about 0.5 hours to about 24 hours, from about 2 hours to about 16 hours, or from about 4 hours to about 8 hours.

Suitable non-polar solvents are materials in which all of the reactants used herein, i.e., the activator, and the catalyst compound, are at least partially soluble and which are liquid at reaction temperatures. Preferred non-polar solvents are alkanes, such as isopentane, hexane, n-heptane, octane, nonane, and decane, although a variety of other materials including cycloalkanes, such as cyclohexane, aromatics, such as benzene, toluene, and ethylbenzene, may also be employed.

### Polymerization Processes

In embodiments herein, the invention relates to polymerization processes where monomer (such as ethylene or propylene), and optionally comonomer, are contacted with a catalyst system comprising an activator and at least one catalyst compound, as described above. The catalyst compound and activator may be combined in any order, and are combined typically prior to contacting with the monomer.

Monomers useful herein include substituted or unsubstituted C₂ to C₄₀ alpha olefins, preferably C₂ to C₂₀ alpha olefins, preferably C₂ to C₁₂ alpha olefins, preferably ethylene, propylene, butene, pentene, hexene, heptene, octene, nonene, decene, undecene, dodecene and isomers thereof.

In embodiments of the invention, the monomer comprises propylene and optional comonomer(s) comprising one or more of ethylene and C₄ to C₄₀ olefins, preferably C₄ to C₂₀ olefins, or preferably C₆ to C₁₂ olefins. The C₄ to C₄₀ olefin monomers may be linear, branched, or cyclic. The C₄ to C₄₀ cyclic olefins may be strained or unstrained, monocyclic or polycyclic, and may optionally include heteroatoms and/or one or more functional groups.

In embodiments of the invention, the monomer comprises ethylene and optional comonomer(s) comprising one or more C₃ to C₄₀ olefins, preferably C₄ to C₂₀ olefins, or preferably C₆ to C₁₂ olefins. The C₃ to C₄₀ olefin monomers may be linear, branched, or cyclic. The C₃ to C₄₀ cyclic olefins may be strained or unstrained, monocyclic or polycyclic, and may optionally include heteroatoms and/or one or more functional groups.

Exemplary C₂ to C₄₀ olefin monomers and optional comonomers include ethylene, propylene, butene, pentene, hexene, heptene, octene, nonene, decene, undecene, dodecene, norbornene, norbornadiene, dicyclopentadiene, cyclopentene, cycloheptene, cyclooctene, cyclooctadiene, cyclododecene, 7-oxanorbornene, 7-oxanorbornadiene, substituted derivatives thereof, and isomers thereof, preferably hexene, heptene, octene, nonene, decene, dodecene, cyclooctene, 1,5-cyclooctadiene, 1-hydroxy-4-cyclooctene, 1-acetoxy-4-cyclooctene, cyclopentene, dicyclopentadiene, norbornene, norbornadiene, and their respective homologs and derivatives, preferably norbornene, norbornadiene, and dicyclopentadiene.

In embodiments of the invention one or more dienes are present in the polymer produced herein at up to 10 weight %, preferably at 0.00001 to 1.0 weight %, preferably 0.002 to 0.5 weight %, even more preferably 0.003 to 0.2 weight %, based upon the total weight of the composition. In some embodiments 500 ppm or less of diene is added to the polymerization, preferably 400 ppm or less, preferably or 300 ppm or less. In other embodiments at least 50 ppm of diene is added to the polymerization, or 100 ppm or more, or 150 ppm or more.

Diolefin monomers useful in this invention include any hydrocarbon structure, preferably C₄ to C₃₀, having at least two unsaturated bonds, wherein at least two of the unsaturated bonds are readily incorporated into a polymer by either a stereospecific or a non-stereospecific catalyst(s). It is further preferred that the diolefin monomers be selected from alpha, omega-diene monomers (i.e. di-vinyl monomers). More preferably, the diolefin monomers are linear di-vinyl monomers, most preferably those containing from 4 to 30 carbon atoms. Examples of preferred dienes include butadiene, pentadiene, hexadiene, heptadiene, octadiene, nonadiene, decadiene; undecadiene, dodecadiene, tridecadiene, tetradecadiene, pentadecadiene, hexadecadiene, heptadecadiene, octadecadiene, nonadecadiene, icosadiene, heneicosadiene, docosadiene, tricosadiene; tetracosadiene, pentacosadiene, hexacosadiene, heptacosadiene, octacosadiene, nonacosadiene, triacontadiene, particularly preferred dienes include 1,6-heptadiene, 1,7-octadiene, 1,8-nonadiene, 1,9-decadiene, 1,10-undecadiene, 1,11-dodecadiene, 1,12-tridecadiene, 1,13-tetradecadiene, and polybutadienes having an Mw of less than 1000 g/mol. Preferred cyclic dienes include cyclopentadiene, vinylnorbornene, norbornadiene, ethylidene norbornene, divinylbenzene, dicyclopentadiene or higher ring containing diolefins with or without substituents at various ring positions.

### Polymerization

A solution polymerization is a polymerization process in which the polymer is dissolved in a liquid polymerization medium, such as an inert solvent or monomer(s) or their blends. A solution polymerization is typically homogeneous. A homogeneous polymerization is one where polymer product is dissolved in the polymerization medium, such as 80 wt % or more, 90 wt % or more or 100% of polymer product is dissolved in the reaction medium. Such systems are preferably not turbid as described in J. Vladimir Oliveira, et al. (2000) Md. Eng. Chem. Res., v.29, pg. 4627.

A bulk polymerization means a polymerization process in which the monomers and/or comonomers being polymerized are used as a solvent or diluent using little or no inert solvent as a solvent or diluent. A small fraction of inert solvent might be used as a carrier for catalyst and scavenger. A bulk polymerization system typically contains less than 25 wt % of inert solvent or diluent, preferably less than 10 wt %, preferably less than 1 wt %, preferably 0 wt %.

Polymerization processes of this invention can be carried out in any manner known in the art. Any suspension, homogeneous, bulk, solution, slurry, or gas phase polymerization process known in the art can be used. Such processes can be run in a batch, semi-batch, or continuous mode. Homogeneous polymerization processes are typically useful, such as homogeneous polymerization process where at least 90 wt % of the product is soluble in the reaction media.) A bulk homogeneous process is also useful, such as a process where monomer concentration in all feeds to the reactor is 70 volume % or more. Alternately, no solvent or diluent is present or added in the reaction medium, (except for the small amounts used as the carrier for the catalyst system or other additives, or amounts typically found with the monomer; e.g., propane in propylene). In another embodiment, the process is a slurry process, e.g., a polymerization process typically using a supported catalyst where at least 95 wt % of polymer products derived from the supported catalyst is in granular form as solid particles (not dissolved in the diluent or polymerization medium). In another process, the polymerization process is a gas phase process.

Suitable diluents/solvents for polymerization include non-coordinating, inert liquids. Examples include straight and branched-chain hydrocarbons, such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof, such as can be found commercially (Isopar™ fluids); perhalogenated hydrocarbons, such as perfluorinated C₄₋₁₀ alkanes, chlorobenzene, and aromatic and alkylsubstituted aromatic compounds, such as benzene, toluene, mesitylene, and xylene. Suitable solvents also include liquid olefins which may act as monomers or comonomers including ethylene, propylene, 1-butene, 1-hexene, 1-pentene, 3-methyl-1-pentene, 4-methyl-1-pentene, 1-octene, 1-decene, and mixtures thereof. In a preferred embodiment, aliphatic hydrocarbon solvents are used as the solvent, such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof. In another embodiment, the solvent is not aromatic, preferably aromatics are present in the solvent at less than 1 wt %, preferably less than 0.5 wt %, preferably less than 0 wt % based upon the weight of the solvents.

In a preferred embodiment, the feed concentration of the monomers and comonomers for the polymerization is 60 vol % solvent or less, preferably 40 vol % or less, or preferably 20 vol % or less, based on the total volume of the feedstream. Preferably the polymerization is run in a bulk process.

Preferred polymerizations can be run at any temperature and/or pressure suitable to obtain the desired ethylene polymers. Typical temperatures and/or pressures include a temperature in the range of from about 0° C. to about 300° C., preferably about 20° C. to about 200° C., preferably about 35° C. to about 150° C., preferably from about 40° C. to about 120° C., preferably from about 45° C. to about 80° C.; and at a pressure in the range of from about 0.35 MPa to about 10 MPa, preferably from about 0.45 MPa to about 6 MPa, or preferably from about 0.5 MPa to about 4 MPa.

In a typical polymerization, the run time of the reaction is up to 300 minutes, preferably in the range of from about 5 to 250 minutes, or preferably from about 10 to 120 minutes.

In a some embodiments hydrogen is present in the polymerization reactor at a partial pressure of 0.001 to 50 psig (0.007 to 345 kPa), preferably from 0.01 to 25 psig (0.07 to 172 kPa), more preferably 0.1 to 10 psig (0.7 to 70 kPa).

In an alternate embodiment, the activity of the catalyst is at least 50 g/mmol/hour, preferably 500 or more g/mmol/hour, preferably 5,000 or more g/mmol/hr, preferably 50,000 or more g/mmol/hr. In an alternate embodiment, the conversion of olefin monomer is at least 10%, based upon polymer yield and the weight of the monomer entering the reaction zone, preferably 20% or more, preferably 30% or more, preferably 50% or more, preferably 80% or more.

In a preferred embodiment, little or no alumoxane is used in the process to produce the polymers. Preferably, alumoxane is present at zero mol %, alternately the alumoxane is present at a molar ratio of aluminum to transition metal less than 500:1, preferably less than 300:1, preferably less than 100:1, preferably less than 1:1.

In a preferred embodiment, little or no scavenger is used in the process to produce the ethylene polymer. Preferably, scavenger (such as tri alkyl aluminum) is present at zero mol %, alternately the scavenger is present at a molar ratio of scavenger metal to transition metal of less than 100:1, preferably less than 50:1, preferably less than 15:1, preferably less than 10:1.

In a preferred embodiment, the polymerization: 1) is conducted at temperatures of 0 to 300° C. (preferably 25 to 150° C., preferably 40 to 120° C., preferably 45 to 80° C.); 2) is conducted at a pressure of atmospheric pressure to 10 MPa (preferably 0.35 to 10 MPa, preferably from 0.45 to 6 MPa, preferably from 0.5 to 4 MPa); 3) is conducted in an aliphatic hydrocarbon solvent (such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof; preferably where aromatics are preferably present in the solvent at less than 1 wt %, preferably less than 0.5 wt %, preferably at 0 wt % based upon the weight of the solvents); 4) wherein the catalyst system used in the polymerization comprises less than 0.5 mol %, preferably 0 mol % alumoxane, alternately the alumoxane is present at a molar ratio of aluminum to transition metal less than 500:1, preferably less than 300:1, preferably less than 100:1, preferably less than 1:1; 5) the polymerization preferably occurs in one reaction zone; 6) the activity of the catalyst compound is at least 80,000 g/mmol/hr (preferably at least 150,000 g/mmol/hr, preferably at least 200,000 g/mmol/hr, preferably at least 250,000 g/mmol/hr, preferably at least 300,000 g/mmol/hr, preferably at least 500,000 g/mmol/hr, preferably at least 600,000 g/mmol/hr, preferably at least 700,000 g/mmol/hr); 7) optionally scavengers (such as trialkyl aluminum compounds) are absent (e.g. present at zero mol %, alternately the scavenger is present at a molar ratio of scavenger metal to transition metal of less than 100:1, preferably less than 50:1, preferably less than 15:1, preferably less than 10:1); and 8) optionally hydrogen is present in the polymerization reactor at a partial pressure of 0.001 to 50 psig (0.007 to 345 kPa) (preferably from 0.01 to 25 psig (0.07 to 172 kPa), more preferably 0.1 to 10 psig (0.7 to kPa)). In a preferred embodiment, the catalyst system used in the polymerization comprises no more than one catalyst compound. A “reaction zone” also referred to as a “polymerization zone” is a vessel where polymerization takes place, for example a batch reactor. When multiple reactors are used in either series or parallel configuration, each reactor is considered as a separate polymerization zone. For a multi-stage polymerization in both a batch reactor and a continuous reactor, each polymerization stage is considered as a separate polymerization zone. In a preferred embodiment, the polymerization occurs in one reaction zone. Room temperature is 23° C. unless otherwise noted.

Other additives may also be used in the polymerization, as desired, such as one or more scavengers, promoters, modifiers, reducing agents, oxidizing agents, hydrogen, aluminum alkyls, silanes, or chain transfer agents (such as alkylalumoxanes, a compound represented by the formula AlR₃ or ZnR₂ (where each R is, independently, a C₁-C₈ aliphatic radical, preferably methyl, ethyl, propyl, butyl, penyl, hexyl octyl or an isomer thereof) or a combination thereof, such as diethyl zinc, methylalumoxane, trimethylaluminum, triisobutylaluminum, trioctylaluminum, or a combination thereof).

### Polyolefin Products

This invention also relates to compositions of matter produced by the methods described herein.

The process of this invention produces olefin polymers, preferably ethylene and/or propylene homopolymers and copolymers. In a preferred embodiment, the polymers produced herein are homopolymers of ethylene or propylene, are copolymers of ethylene preferably having from 0 to 25 mole % (alternately from 0.5 to 20 mole %, alternately from 1 to 15 mole %, preferably from 3 to 10 mole %) of one or more C₃ to C₂₀ olefin comonomer (preferably C₃ to C₁₂ alpha-olefin, preferably propylene, butene, hexene, octene, decene, dodecene, preferably propylene, butene, hexene, octene), or are copolymers of propylene preferably having from 0 to 25 mole % (alternately from 0.5 to 20 mole %, alternately from 1 to 15 mole %, preferably from 3 to 10 mole %) of one or more of C₂ or C₄ to C₂₀ olefin comonomer (preferably ethylene or C₄ to C₁₂ alpha-olefin, preferably ethylene, butene, hexene, octene, decene, dodecene, preferably ethylene, butene, hexene, octene).

In a preferred embodiment, the process described herein produces propylene homopolymers or propylene copolymers, such as propylene-ethylene and/or propylene-alphaolefin (preferably C₃ to C₂₀) copolymers (such as propylene-hexene copolymers or propylene-octene copolymers) having: a Mw/Mn of greater than 1 to 4 (preferably greater than 1 to 3).

In a preferred embodiment, the monomer is ethylene and the comonomer is hexene, preferably from 1 to 15 mole % hexene, alternately 1 to 10 mole %.

In embodiments, aromatic solvents, such as toluene, are absent from the polyolefin produced (e.g. present at zero mol %, alternately present at less than 1 mol %, preferably the polymers produced are free of “detectable aromatic hydrocarbon solvent,” such as toluene. For purposes of the present disclosure, “detectable aromatic hydrocarbon solvent” means 0.1 mg/m² or more as determined by gas phase chromatography. For purposes of the present disclosure, “detectable toluene” means 0.1 mg/m² or more as determined by gas phase chromatography.

The polyolefins produced herein preferably contain 0 ppm (alternately less than 1 ppm) of aromatic hydrocarbon. Preferably, the polyolefins produced herein contain 0 ppm (alternately less than 1 ppm) of toluene.

Typically, the polymers produced herein have an Mw of 5,000 to 1,000,000 g/mol (preferably 25,000 to 750,000 g/mol, preferably 50,000 to 500,000 g/mol) as determined by GPC-4D (see procedure below), and/or an Mw/Mn of greater than 1 to 40 (alternately 1.2 to alternately 1.3 to 10, alternately 1.4 to 5, 1.5 to 4, alternately 1.5 to 3).

### Gel Permeation Chromotography (GPC-4D)

Unless otherwise indicated, the distribution and the moments of molecular weight (Mw, Mn, Mz, Mw/Mn, etc.), the comonomer content and the branching index (g′) are determined by using a high temperature Gel Permeation Chromatography (Polymer Char GPC-IR) equipped with a multiple-channel band-filter based Infrared detector IR5 with a multiple-channel band filter based infrared detector ensemble IR5 with band region covering from about 2,700 cm⁻¹ to about 3,000 cm⁻¹ (representing saturated C—H stretching vibration), an 18-angle light scattering detector and a viscometer. Three Agilent PLgel 10-μm Mixed-B LS columns are used to provide polymer separation. Reagent grade 1,2,4-trichlorobenzene (TCB) (from Sigma-Aldrich) comprising ˜300 ppm antioxidant BHT can be used as the mobile phase at a nominal flow rate of ˜1.0 mL/min and a nominal injection volume of ˜200 μL. The whole system including transfer lines, columns, and detectors can be contained in an oven maintained at ˜145° C. A given amount of sample can be weighed and sealed in a standard vial with ˜10 μL flow marker (heptane) added thereto. After loading the vial in the auto-sampler, the oligomer or polymer may automatically be dissolved in the instrument with ˜8 mL added TCB solvent at ˜160° C. with continuous shaking. The sample solution concentration can be from ˜0.2 to ˜2.0 mg/ml, with lower concentrations used for higher molecular weight samples. The concentration, c, at each point in the chromatogram can be calculated from the baseline-subtracted IR5 broadband signal, I, using the equation: c=αI, where α is the mass constant determined with polyethylene or polypropylene standards. The mass recovery can be calculated from the ratio of the integrated area of the concentration chromatography over elution volume and the injection mass which is equal to the pre-determined concentration multiplied by injection loop volume. The conventional molecular weight (IR MW) is determined by combining universal calibration relationship with the column calibration which is performed with a series of monodispersed polystyrene (PS) standards ranging from 700 to 10 M gm/mole. The MW at each elution volume is calculated with following equation:

$$log M = \frac{log ( {K}_{P S} / K )}{α + 1} + \frac{{α}_{P S} + 1}{α + 1} log {M}_{P S}$$

where the variables with subscript “PS” stand for polystyrene while those without a subscript are for the test samples. In this method, α_{PS}=0.67 and K_{PS}=0.000175, and a and K for other materials are calculated by GPC ONE™ 2019f software (Polymer Characterization, S.A., Valencia, Spain). Concentrations are expressed in g/cm³, molecular weight is expressed in g/mole, and intrinsic viscosity (hence K in the Mark-Houwink equation) is expressed in dL/g unless otherwise noted.

The comonomer composition is determined by the ratio of the IR5 detector intensity corresponding to CH₂ and CH₃ channel calibrated with a series of PE and PP homo/copolymer standards whose nominal value are predetermined by NMR or FTIR. In particular, this provides the methyls per 1,000 total carbons (CH₃/1000TC) as a function of molecular weight. The short-chain branch (SCB) content per 1000TC (SCB/1000TC) is then computed as a function of molecular weight by applying a chain-end correction to the CH₃/1000TC function, assuming each chain to be linear and terminated by a methyl group at each end. The weight % comonomer is then obtained from the following expression in which f is 0.3, 0.4, 0.6, 0.8, and so on for C₃, C₄, C₆, C₈, and so on co-monomers, respectively:

w2=f*SCB/1000TC.

The bulk composition of the polymer from the GPC-IR and GPC-4D analyses is obtained by considering the entire signals of the CH₃ and CH₂ channels between the integration limits of the concentration chromatogram. First, the following ratio is obtained

$$Bulk IR ratio = \frac{Area of {CH}_{3} signal within integration limits}{Area of {CH}_{2} signal within integration limits} .$$

Then the same calibration of the CH₃ and CH₂ signal ratio, as mentioned previously in obtaining the CH₃/1000TC as a function of molecular weight, is applied to obtain the bulk CH₃/1000TC. A bulk methyl chain ends per 1000TC (bulk CH3end/1000TC) is obtained by weight-averaging the chain-end correction over the molecular-weight range. Then

w2b=f*bulk CH3/1000TC

bulk SCB/1000TC=bulk CH₃/1000TC−bulk CH3end/1000TC and bulk SCB/1000TC is converted to bulk w2 in the same manner as described above.

The LS detector is the 18-angle Wyatt Technology High Temperature DAWN HELEOSII. The LS molecular weight (M) at each point in the chromatogram is determined by analyzing the LS output using the Zimm model for static light scattering (Light Scattering from Polymer Solutions; Huglin, M. B., Ed.; Academic Press, 1972.):

$$\frac{{K}_{0} c}{Δ R ( θ )} = \frac{1}{M P ( θ )} + 2 {A}_{2} c .$$

Here, ΔR(θ) is the measured excess Rayleigh scattering intensity at scattering angle θ, c is the polymer concentration determined from the IR5 analysis, A₂ is the second virial coefficient, P(θ) is the form factor for a monodisperse random coil, and K₀ is the optical constant for the system:

$${K}_{0} = \frac{4 {π}^{2} {{n}^{2} ( dn / d c )}^{2}}{{λ}^{4} {N}_{A}}$$

where N_{A} is Avogadro's number, (dn/dc) is the refractive index increment for the system, n=1.500 for TCB at 145° C., and λ=665 nm. For analyzing polyethylene homopolymers, ethylene-hexene copolymers, and ethylene-octene copolymers, dn/dc=0.1048 ml/mg and A₂=0.0015; for analyzing ethylene-butene copolymers, dn/dc=0.1048*(1−0.00126*w2) ml/mg and A₂=0.0015 where w2 is weight percent butene comonomer.

A high temperature Agilent (or Viscotek Corporation) viscometer, which has four capillaries arranged in a Wheatstone bridge configuration with two pressure transducers, is used to determine specific viscosity. One transducer measures the total pressure drop across the detector, and the other, positioned between the two sides of the bridge, measures a differential pressure. The specific viscosity, η_{S}, for the solution flowing through the viscometer is calculated from their outputs. The intrinsic viscosity, [η], at each point in the chromatogram is calculated from the equation [η]=η_{S}/c, where c is concentration and is determined from the IR5 broadband channel output. The viscosity MW at each point is calculated as M=K_{PS}M^{α}^{_{PS}}⁺¹/[η], where αₚₛ is 0.67 and Kₚₛ is 0.000175.

The branching index (g′ᵥᵢₛ) is calculated using the output of the GPC-IR5-LS-VIS method as follows. The average intrinsic viscosity, [η]_{avg}, of the sample is calculated by:

$${[ η ]}_{a v g} = \frac{\sum {{c}_{1} [ η ]}_{1}}{\sum {c}_{1}}$$

where the summations are over the chromatographic slices, i, between the integration limits. The branching index g′ᵥᵢₛ is defined as

$${g}_{vis}^{′} = \frac{{[ η ]}_{avg}}{K {M}_{v}^{α}} ,$$

where M_{V} is the viscosity-average molecular weight based on molecular weights determined by LS analysis and the K and a are for the reference linear polymer, which are, for purposes of this invention and claims thereto, calculated by GPC ONE™ 2019f software (Polymer Characterization, S.A., Valencia, Spain). Concentrations are expressed in g/cm³, molecular weight is expressed in g/mole, and intrinsic viscosity (hence K in the Mark-Houwink equation) is expressed in dL/g unless otherwise noted. Calculation of the w2b values is as discussed above.

### Blends

In another embodiment, the polymer (preferably the polyethylene or polypropylene) produced herein is combined with one or more additional polymers prior to being formed into a film, molded part or other article. Other useful polymers include polyethylene, isotactic polypropylene, highly isotactic polypropylene, syndiotactic polypropylene, random copolymer of propylene and ethylene, and/or butene, and/or hexene, polybutene, ethylene vinyl acetate, LDPE, LLDPE, HDPE, ethylene vinyl acetate, ethylene methyl acrylate, copolymers of acrylic acid, polymethylmethacrylate or any other polymers polymerizable by a high-pressure free radical process, polyvinylchloride, polybutene-1, isotactic polybutene, ABS resins, ethylene-propylene rubber (EPR), vulcanized EPR, EPDM, block copolymer, styrenic block copolymers, polyamides, polycarbonates, PET resins, cross linked polyethylene, copolymers of ethylene and vinyl alcohol (EVOH), polymers of aromatic monomers such as polystyrene, poly-1 esters, polyacetal, polyvinylidine fluoride, polyethylene glycols, and/or polyisobutylene.

In a preferred embodiment, the polymer (preferably a polyethylene or polypropylene) is present in the above blends, at from 10 to 99 wt %, based upon the weight of the polymers in the blend, preferably 20 to 95 wt %, even more preferably at least 30 to 90 wt %, even more preferably at least 40 to 90 wt %, even more preferably at least 50 to 90 wt %, even more preferably at least 60 to 90 wt %, even more preferably at least 70 to 90 wt %.

The blends described above may be produced by mixing the polymers of the invention with one or more polymers (as described above), by connecting reactors together in series to make reactor blends or by using more than one catalyst in the same reactor to produce multiple species of polymer. The polymers can be mixed together prior to being put into the extruder or may be mixed in an extruder.

The blends may be formed using conventional equipment and methods, such as by dry blending the individual components and subsequently melt mixing in a mixer, or by mixing the components together directly in a mixer, such as, for example, a Banbury mixer, a Haake mixer, a Brabender internal mixer, or a single or twin-screw extruder, which may include a compounding extruder and a side-arm extruder used directly downstream of a polymerization process, which may include blending powders or pellets of the resins at the hopper of the film extruder. Additionally, additives may be included in the blend, in one or more components of the blend, and/or in a product formed from the blend, such as a film, as desired. Such additives are well known in the art, and can include, for example: fillers; antioxidants (e.g., hindered phenolics such as IRGANOX™ 1010 or IRGANOX™ 1076 available from Ciba-Geigy); phosphites (e.g., IRGAFOS™ 168 available from Ciba-Geigy); anti-cling additives; tackifiers, such as polybutenes, terpene resins, aliphatic and aromatic hydrocarbon resins, alkali metal and glycerol stearates, and hydrogenated rosins; UV stabilizers; heat stabilizers; anti-blocking agents; release agents; anti-static agents; pigments; colorants; dyes; waxes; silica; fillers; talc; and the like.

### End Uses

Any of the foregoing polymers and compositions in combination with optional additives (anti-oxidants, colorants, dyes, stabilizers, filler, etc.) may be used in a variety of end-use applications produced by methods known in the art. Exemplary end uses are films, film-based products, diaper backsheets, housewrap, wire and cable coating compositions, articles formed by molding techniques, e.g., injection or blow molding, extrusion coating, foaming, casting, and combinations thereof. End uses also include products made from films, e.g., bags, packaging, and personal care films, pouches, medical products, such as for example, medical films and intravenous (IV) bags.

In another embodiment, this invention relates to:

1. A non-aromatic hydrocarbon soluble catalyst compound represented by the Formula (X):

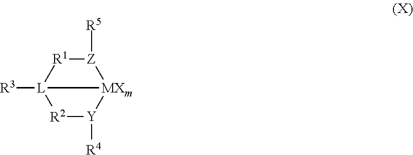

wherein:
M is a Group 4 metal;
each X is independently a leaving group, such as an anionic leaving group;
m is 1, 2 or 3;
L is a Group 15 or 16 element;
Y and Z are independently phosphorus, nitrogen sulfur, or oxygen;
R¹ and R² are, independently, a C₁ to C₂₀ hydrocarbon group, a heteroatom containing group having up to twenty carbon atoms, silicon, germanium, tin, lead, or phosphorus, R¹ and R² may also be interconnected to each other directly or bound to each other through other groups);
R³ may be absent or may be a hydrocarbon group, a hydrogen, a halogen, a heteroatom containing group; and
each R⁴ and R⁵ is independently a substituted C₅ to C₂₂ aromatic group,
wherein the catalyst compound is soluble in methylcyclohexane at greater than 10 weight percent at 25° C.

2. The non-aromatic hydrocarbon soluble catalyst compound of paragraph 1, wherein the catalyst compound is soluble in isohexane at greater than 1.5 weight at 25° C.

3. The non-aromatic hydrocarbon soluble catalyst compound of paragraph 1 or 2, wherein R¹ and R² are, independently, a C₁, C₂ or C₃ hydrocarbon group.

4. The non-aromatic hydrocarbon soluble catalyst compound of any of paragraphs 1 to 3, wherein the catalyst compound is absent aromatic hydrocarbon.

5. The non-aromatic hydrocarbon soluble catalyst compound of any of paragraphs 1 to 4, wherein each R⁴ and R⁵ is independently a C₆ to C₂₂ substituted phenyl group, a C₆ to C₂₂ substituted benzyl group, a C₆ to C₂₂ substituted naphthyl group, or a C₆ to C₂₂ substituted anthracenyl group.

6. The non-aromatic hydrocarbon soluble catalyst compound of any of paragraphs 1 to 5, wherein each R⁴ and R⁵ is independently a hydrocarbyl substituted phenyl group represented by the formula:

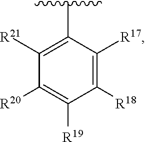

where each of R¹⁷, R¹⁸, R²⁰, and R²¹ is independently selected from hydrogen, C₁-C₄₀ hydrocarbyl or C₁-C₄₀ substituted hydrocarbyl, a heteroatom or a heteroatom-containing group, or two or more of R¹⁷, R¹⁸, R¹⁹, R²⁰, and R²¹ are joined together to form a C₄-C₆₂ cyclic or polycyclic ring structure, or a combination thereof;
each R¹⁹ is independently selected from C₃-C₂₂ hydrocarbyl or C₁-C₂₂ substituted hydrocarbyl, a heteroatom or a heteroatom-containing group.

7. The non-aromatic hydrocarbon soluble catalyst compound of paragraph 6, wherein each R¹⁹ is independently one or more of C₃ to C₁₆ linear or branched alkyl.

8. The non-aromatic hydrocarbon soluble catalyst compound of paragraph 6, wherein each R¹⁹ is independently one or more of propyl, butyl, pentyl, hexyl, heptyl, octyl, nonyl, decyl, undecyl, dodecyl, tridecyl, tetradecyl, pentadecyl, hexadecyl, heptadecyl, phenyl, methylphenyl and dimethylphenyl, benzyl, methylbenzyl, naphthyl, cyclohexyl, cyclohexenyl, methylcyclohexyl or an isomer thereof.

9. The non-aromatic hydrocarbon soluble catalyst compound of any of paragraphs 1 to 8, wherein each X is, independently, selected from the group consisting of hydrocarbyl radicals having from 1 to 20 carbon atoms, hydrides, amides, alkoxides, sulfides; phosphides, halides, dienes, amines, phosphines, ethers, and a combination thereof, or two X's form a part of a fused ring or a ring system.

10. The non-aromatic hydrocarbon soluble catalyst compound of paragraph 1, wherein the compound is represented by Formula (XII):

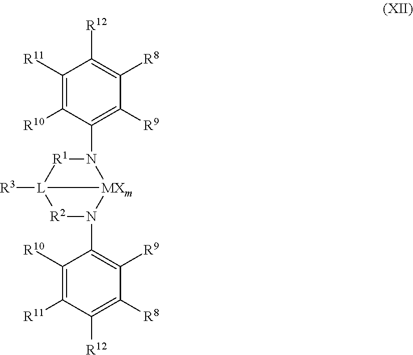

wherein:
M is a zirconium, titanium, or hafnium;
each X is independently a leaving group;
m is 1, 2 or 3;
R¹ and R² are, independently, a C₁ to C₃ hydrocarbon group, a heteroatom containing group having up to twenty carbon atoms, silicon, germanium, tin, lead, or phosphorus;
R³ may be absent or may be a hydrocarbon group, a hydrogen, a halogen, a heteroatom containing group;
each R⁸, R⁹, R¹⁰, and R¹¹ is independently hydrogen, a C₁ to C₁₆ alkyl group, a heteroatom, or a heteroatom containing group containing up to 16 carbon atoms; and
each R¹² is independently hydrogen, a C₃ to C₁₆ alkyl group, a substituted C₃ to C₁₆ alkyl group, a C₆ to C₁₆ aryl group, or a substituted C₆ to C₁₆ aryl group.

11. The non-aromatic hydrocarbon soluble catalyst compound of paragraph 1, wherein the catalyst compound comprises one or more of:
[N′-(2,3,5,6-tetramethyl-4-dodceyl-phenyl)-N-[2-(2,3,5,6-tetramethyl-4-dodecyl-phenyl)amino-κN]ethyl]-1,2-ethane-diaminato(2-)κN,κN]zirconium dichloride;
[N′-(2,3,5,6-tetramethyl-4-decyl-phenyl)-N-[2-(2,3,5,6-tetramethyl-4-decyl-phenyl)amino-κN]ethyl]-1,2-ethane-diaminato(2-)κN,κN]zirconium dichloride;
[N′-(2,3,5,6-tetramethyl-4-tetradecyl,-phenyl)-N-[2-(2,3,5,6-tetramethyl-4-tetradecyl; -phenyl)amino-κN]ethyl]-1,2-ethane-diaminato(2-)κN,κN]zirconium dichloride;
[N′-(2,3,5,6-tetramethyl-4-hexadecyl,-phenyl)-N-[2-(2,3,5,6-tetramethyl-4-hexadecyl,-phenyl)amino-κN]ethyl]-1,2-ethane-diaminato(2-)κN,κN]zirconium dichloride;
[N′-(2,3,5,6-tetramethyl-4-octadecyl,-phenyl)-N-[2-(2,3,5,6-tetramethyl-4-octadecyl,-phenyl)amino-κN]ethyl]-1,2-ethane-diaminato(2-)κN,κN′]zirconium dichloride;
[N′-(2,3,5,6-tetramethyl-4-eicosyl,-phenyl)-N-[2-(2,3,5,6-tetramethyl-4-eicosyl, -phenyl)amino-κN]ethyl]-1,2-ethane-diaminato(2-)κN,κN′]zirconium dichloride;
[N′-(2,3,5,6-tetramethyl-4-docosyl,-phenyl)-N-[2-(2,3,5,6-tetramethyl-4-docosyl,-phenyl)amino-κN]ethyl]-1,2-ethane-diaminato(2-)κN,κN′]zirconium dichloride;
[N′-(2,3,5,6-tetramethyl-4-dodceyl-phenyl)-N-[2-(2,3,5,6-tetramethyl-4-dodecyl-phenyl)amino-κN]ethyl]-1,2-ethane-diaminato(2-)κN,κN]zirconium dibenzyl;
[N′-(2,3,5,6-tetramethyl-4-decyl-phenyl)-N-[2-(2,3,5,6-tetramethyl-4-decyl-phenyl)amino-κN]ethyl]-1,2-ethane-diaminato(2-)κN,κM′]zirconium dibenzyl; and
[N′-(4-decyl-phenyl)-N-[2-(4-decyl-phenyl)amino-κN]ethyl]-1,2-ethane-diaminato(2-) κN,κN]zirconium dibenzyl.

12. A catalyst system comprising activator, optional support, and non-aromatic hydrocarbon soluble catalyst compound of any of paragraphs 1 to 11.

13. The catalyst system of paragraph 12 wherein the catalyst system is absent aromatic hydrocarbon.

14. The catalyst system of paragraph 12 wherein the catalyst system is supported.

15. The catalyst system of paragraph 12 or 13, wherein the activator comprises a non-coordinating anion activator.

16. The catalyst system of paragraph 12 to 13, wherein the activator is represented by the formula:

(Z)_{d}⁺(A^{d-})

wherein Z is (L-H) or a reducible Lewis Acid, L is an neutral Lewis base; H is hydrogen; (L-H)⁺ is a Bronsted acid; A^{d-} is a non-coordinating anion having the charge d−; and d is 1, 2 or 3.

17. The catalyst system of paragraphs 12 or 13, wherein the activator is represented by the formula:

(Z)_{d}⁺(A^{d-})

wherein A^{d-} is a non-coordinating anion having the charge d−; d is 1, 2 or 3, and (Z)_{d}⁺ is represented by the formula:

[R¹′R²′R³′EH]_{d}⁺

wherein E is nitrogen or phosphorous; d is 1, 2 or 3; R¹′, R²′, and R³′ are independently hydrogen or a C₁ to C₅₀ hydrocarbyl group optionally substituted with one or more alkoxy groups, silyl groups, a halogen atoms, or halogen containing groups, wherein R¹′, R²′, and R³′ together comprise 15 or more carbon atoms.

18. The catalyst system of paragraph 12 or 13, wherein the activator is one or more of:
methylalumoxane,
di(octadecyl)tolylammonium [tetrakis(pentafluorophenyl)borate],
di(octadecyl)tolylammonium [tetrakis(perfluoronaphthyl)borate],
di(hydrogenated tallow)methylammonium[tetrakis(pentafluorophenyl)borate],
di(hydrogenated tallow)methylammonium[tetrakis(perfluoronaphthyl)borate]
dioctadecylmethylammonium tetrakis(pentafluorophenyl)borate,
dioctadecylmethylammonium tetrakis(perfluoronaphthyl)borate,
N,N-dimethylanilinium tetrakis(pentafluorophenyl)borate,
N,N-dimethylanilinium tetrakis(perfluoronaphthyl)borate,
N-methyl-4-nonadecyl-N-octadecylanilinium [tetrakis(perfluorophenyl)borate],
N-methyl-4-hexadecyl-N-octadecylanilinium [tetrakis(perfluorophenyl)borate],
N-methyl-4-tetradecyl-N-octadecylanilinium [tetrakis(perfluorophenyl)borate],
N-methyl-4-dodecyl-N-octadecylanilinium [tetrakis(perfluorophenyl)borate],
N-methyl-4-decyl-N-octadecylanilinium [tetrakis(perfluorophenyl)borate],
N-methyl-4-octyl-N-octadecylanilinium [tetrakis(perfluorophenyl)borate],
N-methyl-4-hexyl-N-octadecylanilinium [tetrakis(perfluorophenyl)borate],
N-methyl-4-butyl-N-octadecylanilinium [tetrakis(perfluorophenyl)borate],
N-methyl-4-octadecyl-N-decylanilinium [tetrakis(perfluorophenyl)borate],
N-methyl-4-nonadecyl-N-dodecylanilinium [tetrakis(perfluorophenyl)borate],
N-methyl-4-nonadecyl-N-tetradecylanilinium [tetrakis(perfluorophenyl)borate],
N-methyl-4-nonadecyl-N-hexadecylanilinium [tetrakis(perfluorophenyl)borate],
N-ethyl-4-nonadecyl-N-octadecylanilinium [tetrakis(perfluorophenyl)borate],
N-methyl-N,N-dioctadecylammonium [tetrakis(perfluorophenyl)borate],
N-methyl-N,N-dihexadecylammonium [tetrakis(perfluorophenyl)borate],
N-methyl-N,N-ditetradecylammonium [tetrakis(perfluorophenyl)borate],
N-methyl-N,N-didodecylammonium [tetrakis(perfluorophenyl)borate],
N-methyl-N,N-didecylammonium [tetrakis(perfluorophenyl)borate],
N-methyl-N,N-dioctylammonium [tetrakis(perfluorophenyl)borate],
N-ethyl-N,N-dioctadecylammonium [tetrakis(perfluorophenyl)borate],
N,N-di(octadecyl)tolylammonium [tetrakis(perfluorophenyl)borate],
N,N-di(hexadecyl)tolylammonium [tetrakis(perfluorophenyl)borate],
N,N-di(tetradecyl)tolylammonium [tetrakis(perfluorophenyl)borate],
N,N-di(dodecyl)tolylammonium [tetrakis(perfluorophenyl)borate],
N-octadecyl-N-hexadecyl-tolylammonium [tetrakis(perfluorophenyl)borate],
N-octadecyl-N-hexadecyl-tolylammonium [tetrakis(perfluorophenyl)borate],
N-octadecyl-N-tetradecyl-tolylammonium [tetrakis(perfluorophenyl)borate],
N-octadecyl-N-dodecyl-tolylammonium [tetrakis(perfluorophenyl)borate],
N-octadecyl-N-decyl-tolylammonium [tetrakis(perfluorophenyl)borate],
N-hexadecyl-N-tetradecyl-tolylammonium [tetrakis(perfluorophenyl)borate],
N-hexadecyl-N-dodecyl-tolylammonium [tetrakis(perfluorophenyl)borate],
N-hexadecyl-N-decyl-tolylammonium [tetrakis(perfluorophenyl)borate],
N-tetradecyl-N-dodecyl-tolylammonium [tetrakis(perfluorophenyl)borate],
N-tetradecyl-N-decyl-tolylammonium [tetrakis(perfluorophenyl)borate],
N-dodecyl-N-decyl-tolylammonium [tetrakis(perfluorophenyl)borate],
N-methyl-N-octadecylanilinium [tetrakis(perfluorophenyl)borate],
N-methyl-N-hexadecylanilinium [tetrakis(perfluorophenyl)borate],
N-methyl-N-tetradecylanilinium [tetrakis(perfluorophenyl)borate],
N-methyl-N-dodecylanilinium [tetrakis(perfluorophenyl)borate],
N-methyl-N-decylanilinium [tetrakis(perfluorophenyl)borate], and
N-methyl-N-octylanilinium [tetrakis(perfluorophenyl)borate].

19. The catalyst system any of paragraphs 12 to 18, further comprising metallocene catalyst, such as:
(n-propyl cyclopentadienyl, tetramethyl cyclopentadienyl)zirconium dichloride,
(n-propyl cyclopentadienyl, tetramethyl cyclopentadienyl)zirconium dimethyl,
Bis(n-butylcyclopentadienyl)zirconium dichloride,
Bis(n-butylcyclopentadienyl)zirconium dimethyl,
Bis(1-methyl-3-n-butylcylopentadienyl)zirconium dichloride,
Bis(1-methyl-3-n-butylcylopentadienyl)zirconium dimethyl,
(n-propyl cyclopentadienyl, pentamethyl cyclopentadienyl)zirconium dichloride, and
(n-propyl cyclopentadienyl, pentamethyl cyclopentadienyl)zirconium dimethyl.

20. A process to polymerize olefins comprising contacting one or more olefins with the catalyst system of any of paragraphs 12 to 19.

21. The process of paragraph 20, wherein the process is absent aromatic hydrocarbon.

22. The process of paragraph 20 or 21, wherein the process occurs at a temperature of from about 0° C. to about 300° C., at a pressure in the range of from about 0.35 MPa to about 10 MPa, and at a time up to 300 minutes.

23. The process of paragraph 20, 21 or 22, further comprising obtaining polymer.

24. The process of paragraph 20, 21, 22 or 23 wherein the process occurs in the gas, slurry, or solution phase.

### EXPERIMENTAL

### Materials

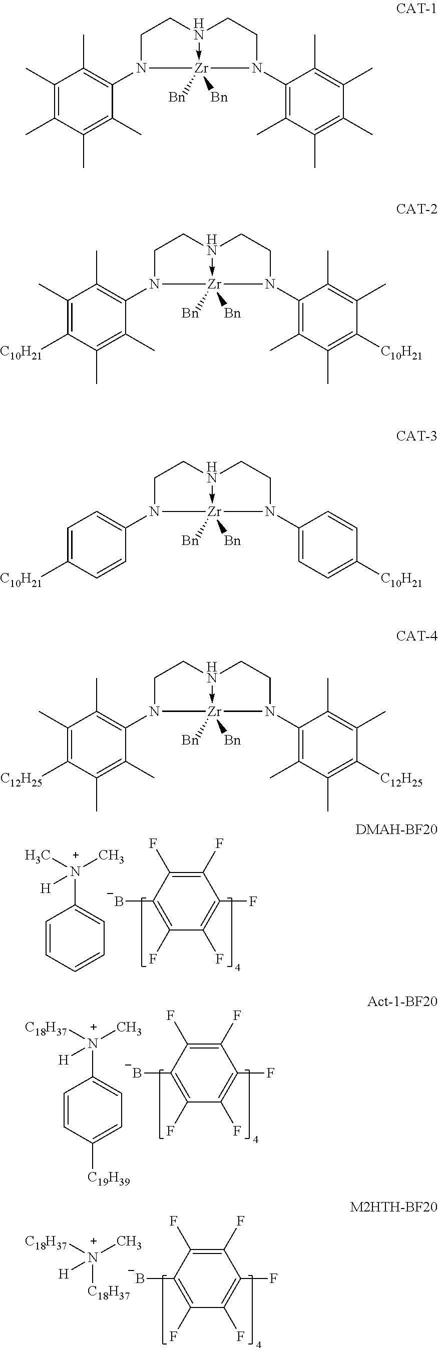

### Examples

General Synthesis of Catalysts: All air and moisture sensitive reactions were performed under a nitrogen atmosphere. Reagents were purchased from commercial vendors and used as received unless otherwise noted. DMAH-BF20 was obtained from W.R. Grace and Conn. ACT-1-BF20 and M2HTH-BF20 were prepared by known routes with lithium tetrakis(pentafluorophenyl)borate etherate (Li-BF20) purchased from Boulder Scientific. All other reagents and solvents were purchased from Sigma-Aldrich. NMR spectra were recorded on a Bruker 500 or 400 NMR with chemical shifts referenced to residual solvent peaks (CDCl₃: 7.27 ppm for ¹H, 77.23 ppm for ¹³C).

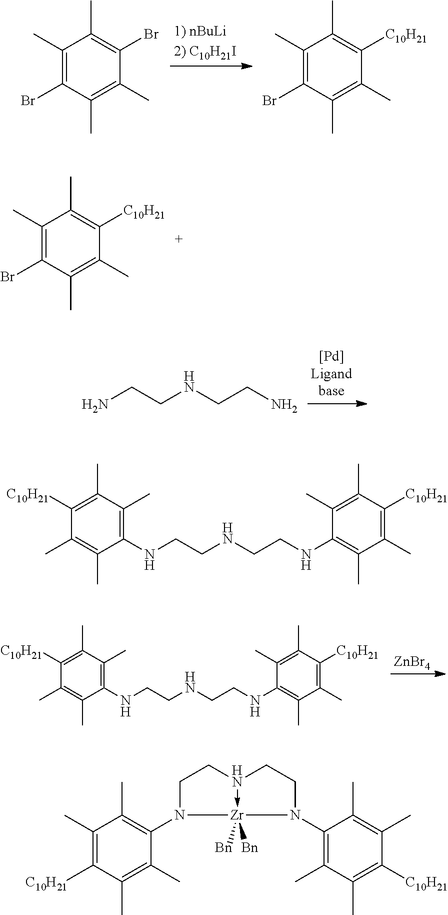

1-bromo-4-decyl-2,3,5,6-tetramethylbenzene: 2.5 M nBuLi (6.85 mL, 0.017 mol) was added slowly to a solution of 1,4-dibromo-2,3,5,6-tetramethylbenzene (5.00 g, 0.017 mol) in 50 mL THF at −78° C. After 30 minutes at −78° C., the 1-iododecane (3.82 mL, 0.017 mol) was added. The reaction remained at −78° C. for 2 hours and then warmed to ambient over minutes. After an aqueous quench followed by organic extraction with 3×EtOAc, organic fractions were combined, rinsed with brine, and dried with MgSO₄. The solution was filtered and concentrated to yield the desired product as a light yellow oil in 85% purity (81% yield). The material was used without further purification. ¹H NMR (400 MHz, CDCl₃, δ): 0.88 (t, J=6.7 Hz, 3H), 1.28 (m, 14H), 1.42 (m, 2H), 2.28 (s, 6H), 2.43 (s, 6H), 2.62 (m, 2H).

Bis(4-decyl-2,3,5,6-tetramethylphenylamidoethyl)amine: The above 1-bromo-4-decyl-2,3,5,6-tetramethylbenzene (2.22 g, 5.33 mmol), diethylene triamine (0.275 g, 2.67 mmol), sodium tert-butoxide (0.640 g, 6.66 mmol) were dissolved in 25 mL DME. Palladium acetate (6 mg, 0.027 mmol) and (R)-1-[(Sp)-2-(Dicyclohexylphosphino)ferrocenyl]ethyldi-tert-butylphosphine (15 mg, 0.027 mmol) were dissolved in 1 mL DME and added to the reactant solution. The reaction was heated to 100° C. After 16 hours, the reaction was cooled, diluted with water, and extracted with 3×DCM. Organic fractions were combined, rinsed with brine, and dried with MgSO₄. The solution was filtered and concentrated to yield the product as an orange solid in 65% yield. ¹H NMR (400 MHz, CDCl₃, δ): 0.89 (m, 6H), 1.29 (m, 28H), 1.43 (m, 4H), 2.22 (s, 12H), 2.26 (s, 12H), 2.61 (m, 4H), 2.98 (m, 4H), 3.03 (m, 4H).

Bis(4-decyl-2,3,5,6-tetramethylphenylamidoethyl)amine zirconium dibenzyl: A solution of tetrabenzyl zirconium (0.176 g, 0.386 mmol) in 2.5 mL toluene was added to a solution of bis(4-decyl-2,3,5,6-tetramethylphenylamidoethyl)amine (0.250 g, 0.386 mmol) in 2.5 mL toluene. The reaction stirred at ambient temperature for 30 minutes. The solution was filtered and concentrated. The resulting brown solid was slurried in pentane and isolated via filtration. The solid was dried to yield the product in 23% yield. ¹H NMR (400 MHz, C₆D₆, δ): 0.89 (m, 6H), 1.27 (m, 28H), 1.53 (m, 4H), 2.27 (s, 6H), 2.34 (s, 6H), 2.41 (s, 6H), 2.45 (s, 6H), 2.70 (m, 4H), 3.11 (m, 4H), 3.43 (m, 4H), 5.65 (m, 4H), 6.89 (m, 6H), 7.24 (m, 4H).

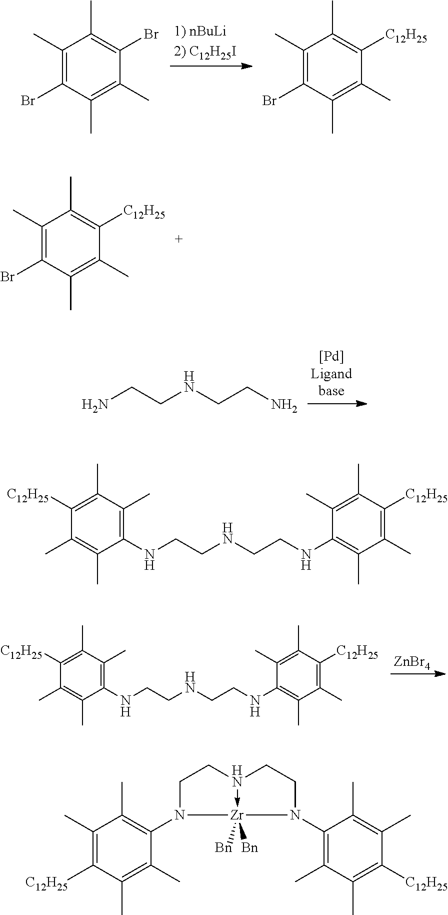

1-bromo-4-dodecyl-2,3,5,6-tetramethylbenzene: 2.5 M nBuLi (7.32 mL, 0.018 mol) was added slowly to a solution of 1,4-dibromo-2,3,5,6-tetramethylbenzene (5.35 g, 0.018 mol) in 50 mL THF at −78° C. After 30 minutes at −78° C., the 1-iodododecane (5.42 g, 0.018 mol) was added. The reaction remained at −78° C. for 2 hours, and then stirred at ambient for 4 hours. After an aqueous quench followed by organic extraction with 3×EtOAc, organic fractions were combined, rinsed with brine, and dried with MgSO₄. The solution was filtered and concentrated to yield a waxy orange solid. The material was recrystallized in cold isohexane to yield the product as a pale orange solid (48% yield). ¹H NMR (400 MHz, CDCl₃, δ): 0.89 (t, J=6.6 Hz, 3H), 1.27 (m, 20H), 1.42 (m, 2H), 2.28 (s, 6H), 2.43 (s, 6H), 2.62 (m, 2H).

Bis(4-dodecyl-2,3,5,6-tetramethylphenylamidoethyl)amine: The above 1-bromo-4-dodecyl-2,3,5,6-tetramethylbenzene (1.41 g, 3.70 mmol), diethylene triamine (0.191 g, 1.85 mmol), sodium tert-butoxide (0.445 g, 4.63 mmol) were dissolved in 25 mL DME. Palladium acetate (4 mg, 0.019 mmol) and (R)-1-[(Sp)-2-(Dicyclohexylphosphino)ferrocenyl]ethyldi-tert-butylphosphine (10 mg, 0.019 mmol) were dissolved in 1 mL DME and added to the reactant solution. The reaction was heated to 100° C. After 16 hours, the reaction was cooled, diluted with water, and extracted with 3×DCM. Organic fractions were combined, rinsed with brine, and dried with MgSO₄. The solution was filtered and concentrated to yield the product as an orange solid in 87% yield. ¹H NMR (400 MHz, CDCl₃, δ): 0.89 (t, J=6.6 Hz, 6H), 1.27 (m, 36H), 1.43 (m, 4H), 2.22 (s, 12H), 2.26 (s, 12H), 2.61 (m, 4H), 2.92 (m, 4H), 2.99 (m, 4H).

Bis(4-dodecyl-2,3,5,6-tetramethylphenylamidoethyl)amine zirconium dibenzyl: A solution of tetrabenzyl zirconium (0.162 g, 0.355 mmol) in 2.5 mL toluene was added to a solution of bis(4-dodecyl-2,3,5,6-tetramethylphenylamidoethyl)amine (0.250 g, mmol) in 2.5 mL toluene. The reaction stirred at ambient temperature for 30 minutes. The solution was filtered and concentrated. The resulting brown solid was slurried in pentane and isolated via filtration. The solid was dried to yield the desired product in 38% yield. ¹H NMR (400 MHz, C₆ D₆, δ): 0.92 (m, 6H), 1.29 (m, 36H), 1.53 (m, 4H), 2.27 (s, 6H), 2.34 (s, 6H), 2.41 (s, 6H), 2.46 (s, 6H), 2.71 (m, 4H), 3.12 (m, 4H), 3.43 (m, 4H), 5.65 (m, 4H), 6.89 (m, 6H), 7.24 (m, 4H).

### High Throughput Polymerization

Solvents, polymerization grade toluene and/or isohexanes are supplied by ExxonMobil Chemical Company and are purified by passing through a series of columns: two 500 cm³ Oxyclear cylinders in series from Labclear (Oakland, California), followed by two 500 cm³ columns in series packed with dried 3 Å molecular sieves (8 mesh-12 mesh; Aldrich Chemical Company), and two 500 cm³ columns in series packed with dried 5 Å molecular sieves (8 mesh-12 mesh; Aldrich Chemical Company).

1-Octene (98%) (Aldrich Chemical Company) is dried by stirring over Na—K alloy overnight followed by filtration through basic alumina (Aldrich Chemical Company, Brockman Basic 1). Tri-(n-octyealuminum (TNOA) are purchased from either Aldrich Chemical Company or Akzo Nobel and are used as received.

Polymerization grade ethylene is further purified by passing it through a series of columns: 500 cm3 Oxyclear cylinder from Labclear (Oakland, California) followed by a 500 cm3 column packed with dried 3 Å molecular sieves (8 mesh-12 mesh; Aldrich Chemical Company), and a 500 cm3 column packed with dried 5 Å molecular sieves (8 mesh-12 mesh; Aldrich Chemical Company).

Polymerization grade propylene is further purified by passing it through a series of columns: 2250 cm3 Oxyclear cylinder from Labclear followed by a 2250 cm3 column packed with 3 Å molecular sieves (8 mesh-12 mesh; Aldrich Chemical Company), then two 500 cm3 columns in series packed with 5 Å molecular sieves (8 mesh-12 mesh; Aldrich Chemical Company), a 500 cm3 column packed with Selexsorb CD (BASF), and finally a 500 cm3 column packed with Selexsorb COS (BASF).

All complexes and the activators are added to the reactor as dilute solutions in toluene. The concentrations of the solutions of activator, scavenger, and complexes that are added to the reactor are chosen so that between 40 microliters-200 microliters of the solution are added to the reactor to ensure accurate delivery.

Reactor Description and Preparation. Polymerizations are conducted in an inert atmosphere (N₂) drybox using autoclaves equipped with an external heater for temperature control, glass inserts (internal volume of reactor=23.5 mL for C₂ and C₂/C₈ runs; 22.5 mL for C₃ runs), septum inlets, regulated supply of nitrogen, ethylene and propylene, and equipped with disposable polyether ether ketone mechanical stirrers (800 RPM). The autoclaves are prepared by purging with dry nitrogen at 110° C. or 115° C. for 5 hours and then at 25° C. for 5 hours.

### Ethylene Polymerization (PE) or Ethylene/l-Octene Copolymerization (EO)

The reactor is prepared as described above, and then is purged with ethylene. Toluene (solvent unless stated otherwise), optional 1-octene (0.1 mL when used), and optional MAO are added via syringe at room temperature and atmospheric pressure. The reactor is then brought to process temperature (typically 80° C.) and charged with ethylene to process pressure (typically 75 psig=618.5 kPa or 200 psig=1480.3 kPa) while stirring at 800 RPM. An optional scavenger solution (e.g., TNOA in isohexane) is then added via syringe to the reactor at process conditions. A non-coordinating activator (such as DMAH-BF20, ACT-1-BF20, and M2HTH-BF20) solution (in solvent, such as toluene or isohexane) is added via syringe to the reactor at process conditions, followed by a pre-catalyst (i.e., complex or catalyst) solution (in toluene) via syringe to the reactor at process conditions. Ethylene is allowed to enter (through the use of computer controlled solenoid valves) the autoclaves during polymerization to maintain reactor gauge pressure (+/−2 psi). Reactor temperature is monitored and typically maintained within +/−1° C. Polymerizations are halted by addition of approximately 50 psi 02/Ar (5 mol % O₂) gas mixture (over the reactor pressure) to the autoclaves for approximately 30 seconds.

The polymerizations are quenched after a predetermined cumulative amount of ethylene is added or for a maximum of 30 minutes polymerization time. The reactors are cooled and vented. The polymer is isolated after the solvent is removed under reduced pressure. Yields to be reported include total weight of polymer and residual catalyst. Catalyst activity is reported as grams of polymer per mmol transition metal compound per hour of reaction time (g/mmol/hr).

### Polymer Characterization

For analytical testing, polymer sample solutions are prepared by dissolving the polymer in 1,2,4-trichlorobenzene (TCB, 99+% purity from Sigma-Aldrich) containing 2,6-di-tert-butyl-4-methylphenol (BHT, 99% from Aldrich) at 165° C. in a shaker oven for approximately 3 hours. The typical concentration of polymer in solution is between 0.1 mg/mL to 0.9 mg/mL with a BHT concentration of 1.25 mg BHT/mL of TCB. Samples are cooled to 135° C. for testing.

High temperature size exclusion chromatography is performed using an automated “Rapid GPC” system as described in U.S. Pat. Nos. 6,491,816; 6,491,823; 6,475,391; 6,461,515; 6,436,292; 6,406,632; 6,175,409; 6,454,947; 6,260,407; and 6,294,388; each of which is incorporated herein by reference. Molecular weights (weight average molecular weight (Mw) and number average molecular weight (Mn)) and molecular weight distribution (MWD=Mw/Mn), which is also sometimes referred to as the polydispersity index (PDI) of the polymer, are measured by Gel Permeation Chromatography using a Symyx Technology GPC equipped with evaporative light scattering detector and calibrated using polystyrene standards (Polymer Laboratories: Polystyrene Calibration Kit S-M-10: Mp (peak Mw) between and 3,390,000). Samples (250 μL of a polymer solution in TCB are injected into the system) are run at an eluent flow rate of 2.0 mL/minute (135° C. sample temperatures, 165° C. oven/columns) using three Polymer Laboratories: PLgel 10 μm Mixed-B 300×7.5 mm columns in series. No column spreading corrections are employed. Numerical analyses are performed using Epoch® software available from Symyx Technologies or Automation Studio software available from Freeslate. The molecular weights obtained are relative to linear polystyrene standards.

Rapid Differential Scanning calorimetry (Rapid-DSC) measurements are performed on a TA-Q100 instrument to determine the melting point of the polymers. Samples are pre-annealed at 220° C. for 15 minutes and then allowed to cool to room temperature overnight. The samples are then heated to 220° C. at a rate of 100° C./minute and then cooled at a rate of 50° C./minute. Melting points are collected during the heating period.

Samples for infrared analysis are prepared by depositing the stabilized polymer solution onto a silanized wafer (Part number S10860, Symyx). By this method, approximately between 0.12 mg and 0.24 mg of polymer is deposited on the wafer cell. The samples are subsequently analyzed on a Bruker Equinox 55 FTIR spectrometer equipped with Pikes' MappIR specular reflectance sample accessory. Spectra, covering a spectral range of 5,000 cm-1 to 500 cm-1, are collected at a 2 cm-1 resolution with 32 scans.

For ethylene-1-octene copolymers, the wt % copolymer is determined via measurement of the methyl deformation band at 1,375 cm-1. The peak height of this band is normalized by the combination and overtone band at 4,321 cm-1, which corrects for path length differences. The normalized peak height is correlated to individual calibration curves from ¹H NMR data to predict the wt % copolymer content within a concentration range of ˜2 wt % to 35 wt % for octene. Typically, IV correlations of 0.98 or greater are achieved. Reported values below 4.1 wt % are outside the calibration range.

### Polymerization Examples

### Polymerization in a High Throughput Parallel Pressure Reactor

Ethylene-octene copolymerization (EO). A series of ethylene-octene polymerizations were performed in the parallel pressure reactor according to the procedure described above. In these experiments, the experimental catalysts CAT-2, CAT-3, CAT-4 were run against the comparative example CAT-1. Catalysts were activated by MAO or ammonium borate activators (DMAH-BF20, ACT-1-BF20, and M2HTH-BF20). In a typical experiment an automated syringe was used to introduce into the reactor the following reagents, if utilized, in the following order: a toluene solution of MAO (0.01 mmol, 0.50%) for entries 1-4, 17-20, and 33-36, isohexane (0.50 mL), 1-octene (100 μL), additional isohexane (0.50 mL), an isohexane solution of TNOAL scavenger (0.005 M, 100 μL) for entries 5-16, 21-32, and 37-48, additional isohexane (0.50 mL), a toluene solution of the respective polymerization catalyst (50 IA, 0.4 mM), additional isohexane (0.50 mL), a toluene solution of the respective activator (55 μL, 0.4 mM) for entries 5-16, 21-32, and 37-48, then additional isohexane so that the total solvent volume for each run was 5 mL. Catalyst and activator were used in a 1:500 ratio for MAO and a 1:1.1 ratio for ammonium borate activators. Each reaction was performed at a specified temperature range between 50 and 120° C., typically 100° C., while applying about 100 psig of ethylene (monomer) gas. Each reaction was allowed to run for about 20 minutes (1200 seconds) or until approximately 20 psig of ethylene gas uptake was observed, at which point the reactions were quenched with air (˜300 psig). When sufficient polymer yield was attained (e.g., at least ˜10 mg), the polyethylene product was analyzed by Rapid GPC described above. Run conditions and data are reported in Tables 1 and 2.

TABLE 1
RUN-1. Data for the ethylene-octene copolymerization.
General conditions: catalyst = 20 nmol; activator = 22 nmol; 1-octene = 100 μL; solvent =
isohexane; volume = 5 mL; tri(n-octyl)aluminum = 500 nmol; T = 100° C.; P = 100 PSI

| | | | | | | | | | octene | |
|---|---|---|---|---|---|---|---|---|---|---|
| | | | time | yield | activity | | | | incorporation | Tₘ |
| Entry | Catalyst | Activator | (s) | (g) | (kg/mmol/h) | M_{w (g/mol)} | M_{n (g/mol)} | M_{w}/Mₙ | (wt %) | (° C.) |
| 1 | CAT-1 | MAO | 38.7 | 0.082 | 381.4 | 164,263 | 97,805 | 1.7 | 9.5 | 107.5 |
| 2 | CAT-1 | MAO | 36.7 | 0.078 | 382.6 | 174,882 | 101,398 | 1.7 | 9.9 | 107.9 |
| 3 | CAT-1 | MAO | 29.2 | 0.084 | 517.8 | 158,223 | 84,862 | 1.9 | 9.9 | 107.4 |
| 4 | CAT-1 | MAO | 30.2 | 0.075 | 447.0 | 146,654 | 83,802 | 1.8 | 10.9 | 106.5 |
| 5 | CAT-1 | DMAH-BF20 | 213.6 | 0.046 | 38.8 | 202,506 | 123,303 | 1.6 | 8.6 | 107.9 |
| 6 | CAT-1 | DMAH-BF20 | 174.6 | 0.045 | 46.4 | 196,533 | 117,317 | 1.7 | 8.0 | 109.9 |
| 7 | CAT-1 | DMAH-BF20 | 457.7 | 0.047 | 18.5 | 205,974 | 111,539 | 1.8 | 8.5 | 108.4 |
| 8 | CAT-1 | DMAH-BF20 | 28.1 | 0.079 | 506.0 | 176,638 | 106,355 | 1.7 | 14.3 | 104.8 |
| 9 | CAT-1 | Act-1-BF20 | 35.2 | 0.067 | 342.6 | 159,541 | 94,185 | 1.7 | 13.9 | 103.0 |
| 10 | CAT-1 | Act-BF20 | 35.3 | 0.076 | 387.5 | 173,349 | 107,273 | 1.6 | 14.2 | 103.6 |
| 11 | CAT-1 | Act-BF20 | 91.8 | 0.051 | 100.0 | 171,452 | 102,555 | 1.7 | 9.7 | 105.4 |
| 12 | CAT-1 | Act--BF20 | 26.7 | 0.081 | 546.1 | 174,325 | 99,148 | 1.8 | 14.6 | 102.5 |
| 13 | CAT-1 | M2HTH-BF20 | 811.6 | 0.044 | 9.8 | 187,296 | 100,775 | 1.9 | 9.8 | 109.7 |
| 14 | CAT-1 | M2HTH-BF20 | 52.1 | 0.059 | 203.8 | 173,393 | 99,974 | 1.7 | 13.2 | 105.1 |
| 15 | CAT-1 | M2HTH-BF20 | 27.1 | 0.089 | 591.1 | 176,583 | 101,414 | 1.7 | 13.9 | 104.1 |
| 16 | CAT-1 | M2HTH-BF20 | 25.2 | 0.073 | 521.4 | 151,028 | 83,948 | 1.8 | 14.5 | 104.8 |
| 17 | CAT-2 | MAO | 32.0 | 0.082 | 461.3 | 152,389 | 100,104 | 1.5 | 11.7 | 104.9 |
| 18 | CAT-2 | MAO | 29.3 | 0.078 | 479.2 | 163,932 | 90,014 | 1.8 | 11.4 | 105.3 |
| 19 | CAT-2 | MAO | 26.5 | 0.083 | 563.8 | 176,857 | 96,146 | 1.8 | 10.3 | 105.1 |
| 20 | CAT-2 | MAO | 28.5 | 0.083 | 524.2 | 174,421 | 97,587 | 1.8 | 12.4 | 105.3 |
| 21 | CAT-2 | DMAH-BF20 | 28.4 | 0.08 | 507.0 | 190,547 | 110,537 | 1.7 | 15.5 | 101.3 |
| 22 | CAT-2 | DMAH-BF20 | 28.5 | 0.074 | 467.4 | 203,654 | 113,941 | 1.8 | 13.2 | 103.5 |
| 23 | CAT-2 | DMAH-BF20 | 31.9 | 0.077 | 434.5 | 187,156 | 102,824 | 1.8 | 15.6 | 101.5 |
| 24 | CAT-2 | DMAH-BF20 | 23.4 | 0.084 | 646.2 | 193,999 | 98,553 | 2.0 | 14.4 | 102.5 |
| 25 | CAT-2 | Act-BF20 | 30.2 | 0.077 | 458.9 | 190,349 | 104,833 | 1.8 | 11.9 | 102.5 |
| 26 | CAT-2 | Act-BF20 | 22.3 | 0.092 | 742.6 | 203,945 | 116,277 | 1.8 | 15.9 | 101.8 |
| 27 | CAT-2 | Act-BF20 | 33.1 | 0.076 | 413.3 | 188,811 | 112,413 | 1.7 | 14.1 | 102.0 |
| 28 | CAT-2 | Act-BF20 | 30.7 | 0.093 | 545.3 | 185,868 | 104,579 | 1.8 | 16.7 | 101.3 |
| 29 | CAT-2 | M2HTH-BF20 | 31.8 | 0.078 | 441.5 | 187,669 | 97,523 | 1.9 | 15.3 | 101.5 |
| 30 | CAT-2 | M2HTH-BF20 | 23.5 | 0.087 | 666.4 | 176,925 | 110,698 | 1.6 | 19.0 | 101.7 |
| 31 | CAT-2 | M2HTH-BF20 | 27.8 | 0.089 | 576.3 | 176,872 | 94,325 | 1.9 | 18.8 | 103.8 |
| 32 | CAT-2 | M2HTH-BF20 | 29.8 | 0.083 | 501.3 | 182,223 | 90,079 | 2.0 | 15.5 | 103.5 |
| 33 | CAT-3 | MAO | 1200 | 0.003 | 0.4 | | | | | |
| 34 | CAT-3 | MAO | 1201 | 0.004 | 0.6 | | | | | |
| 35 | CAT-3 | MAO | 1200 | 0.004 | 0.6 | | | | | |
| 36 | CAT-3 | MAO | 1201 | 0.006 | 0.9 | | | | | |
| 37 | CAT-3 | DMAH-BF20 | 1200 | 0.001 | 0.1 | | | | | |
| 38 | CAT-3 | DMAH-BF20 | 1201 | 0.016 | 2.4 | 223,752 | 137,483 | 1.6 | 8.1 | 112.7 |
| 39 | CAT-3 | DMAH-BF20 | 1201 | 0.001 | 0.1 | | | | | |
| 40 | CAT-3 | DMAH-BF20 | 1200 | 0.01 | 1.5 | | | | | |
| 41 | CAT-3 | Act-BF20 | 1201 | 0.002 | 0.3 | | | | | |
| 42 | CAT-3 | Act-BF20 | 1201 | 0.009 | 1.3 | | | | | |
| 43 | CAT-3 | Act-BF20 | 1200 | 0.001 | 0.1 | | | | | |
| 44 | CAT-3 | Act-BF20 | 1201 | 0.005 | 0.7 | | | | | |
| 45 | CAT-3 | M2HTH-BF20 | 1200 | 0.002 | 0.3 | | | | | |
| 46 | CAT-3 | M2HTH-BF20 | 1200 | 0.005 | 0.7 | | | | | |
| 47 | CAT-3 | M2HTH-BF20 | 1201 | 0.002 | 0.3 | | | | | |
| 48 | CAT-3 | M2HTH-BF20 | 1200 | 0.007 | 1.0 | | | | | |

TABLE 2
RUN-2. Data for the ethylene-octene copolymerization.
General conditions: catalyst = 20 nmol; activator = 22 nmol;
1-octene = 100 μL; solvent = isohexane; volume = 5 mL;
tri(n-octyl)aluminum = 500 nmol; T = 100° C.; P = 100 PSI

| | | | | | | | | | octene | |
|---|---|---|---|---|---|---|---|---|---|---|
| | | | time | yield | activity | | | | incorporation | Tₘ |
| Entry | Catalyst | Activator | (s) | (g) | (kg/mmol/h) | M_{w} | Mₙ | PDI | (wt %) | (° C.) |
| 1 | CAT-1 | MAO | 28.9 | 0.081 | 504.5 | 139,893 | 85,067 | 1.6 | 12.0 | 106.3 |
| 2 | CAT-1 | MAO | 32.1 | 0.083 | 465.4 | 137,747 | 91,576 | 1.5 | 12.4 | 107.3 |
| 3 | CAT-1 | MAO | 28.6 | 0.082 | 516.1 | 153,544 | 91,368 | 1.7 | 12.4 | 106.9 |
| 4 | CAT-1 | MAO | 29.4 | 0.076 | 465.3 | 147,532 | 90,998 | 1.6 | 12.9 | 105.5 |
| 5 | CAT-1 | DMAH-BF20 | 32.9 | 0.084 | 459.6 | 203,506 | 124,824 | 1.6 | 16.6 | 102.2 |
| 6 | CAT-1 | DMAH-BF20 | 28.8 | 0.083 | 518.8 | 196,170 | 116,418 | 1.7 | 16.5 | 102.8 |
| 7 | CAT-1 | DMAH-BF20 | 24.1 | 0.089 | 664.7 | 184,477 | 103,675 | 1.8 | 18.8 | 103.5 |
| 8 | CAT-1 | DMAH-BF20 | 26.6 | 0.091 | 615.8 | 202,782 | 111,646 | 1.8 | 18.2 | 102.2 |
| 9 | CAT-1 | Act-BF20 | 23.3 | 0.092 | 710.7 | 175,201 | 98,796 | 1.8 | 21.2 | 99.5 |
| 10 | CAT-1 | Act-BF20 | 26.8 | 0.093 | 624.6 | 195,424 | 108,258 | 1.8 | 17.6 | 101.2 |
| 11 | CAT-1 | Act-BF20 | 21.0 | 0.089 | 762.9 | 160,114 | 90,423 | 1.8 | 18.7 | 100.2 |
| 12 | CAT-1 | Act-BF20 | 26.0 | 0.094 | 650.8 | 172,927 | 97,326 | 1.8 | 19.3 | 100.4 |
| 13 | CAT-1 | M2HTH-BF20 | 23.2 | 0.092 | 713.8 | 181,788 | 101,069 | 1.8 | 20.2 | 101.9 |
| 14 | CAT-1 | M2HTH-BF20 | 26.2 | 0.081 | 556.5 | 190,139 | 106,316 | 1.8 | 19.8 | 100.0 |
| 15 | CAT-1 | M2HTH-BF20 | 22.5 | 0.086 | 688.0 | 171,107 | 93,985 | 1.8 | 18.1 | 105.5 |
| 16 | CAT-1 | M2HTH-BF20 | 25.5 | 0.084 | 592.9 | 181,955 | 101,305 | 1.8 | 19.3 | 103.2 |
| 17 | CAT-2 | MAO | 32.9 | 0.079 | 432.2 | 160,114 | 94,491 | 1.7 | 11.6 | 105.9 |
| 18 | CAT-2 | MAO | 29.9 | 0.080 | 481.6 | 154,740 | 81,745 | 1.9 | 11.4 | 105.6 |
| 19 | CAT-2 | MAO | 26.6 | 0.083 | 561.7 | 168,601 | 83,200 | 2.0 | 13.0 | 105.0 |
| 20 | CAT-2 | MAO | 28.5 | 0.080 | 505.3 | 170,374 | 93,203 | 1.8 | 14.1 | 105.5 |
| 21 | CAT-2 | DMAH-BF20 | 28.2 | 0.094 | 600.0 | 197,377 | 108,812 | 1.8 | 18.4 | 99.9 |
| 22 | CAT-2 | DMAH-BF20 | 29.3 | 0.095 | 583.6 | 206,511 | 121,690 | 1.7 | 18.4 | 100.9 |
| 23 | CAT-2 | DMAH-BF20 | 23.1 | 0.098 | 763.6 | 190,130 | 96,083 | 2.0 | 18.7 | 103.3 |
| 24 | CAT-2 | DMAH-BF20 | 26.7 | 0.095 | 640.4 | 200,644 | 108,757 | 1.8 | 18.1 | 100.4 |
| 25 | CAT-2 | Act-BF20 | 21.5 | 0.099 | 828.8 | 199,164 | 108,050 | 1.8 | 23.0 | 99.8 |
| 26 | CAT-2 | Act-BF20 | 23.4 | 0.097 | 746.2 | 187,079 | 100,882 | 1.9 | 20.1 | 100.7 |
| 27 | CAT-2 | Act-BF20 | 24.5 | 0.092 | 675.9 | 182,552 | 94,819 | 1.9 | 19.2 | 98.7 |
| 28 | CAT-2 | Act-BF20 | 20.9 | 0.094 | 809.6 | 192,424 | 104,765 | 1.8 | 18.0 | 100.9 |
| 29 | CAT-2 | M2HTH-BF20 | 24.6 | 0.099 | 724.4 | 187,672 | 95,976 | 2.0 | 19.8 | 100.5 |
| 30 | CAT-2 | M2HTH-BF20 | 23.6 | 0.092 | 701.7 | 191,932 | 107,011 | 1.8 | 20.8 | 99.2 |
| 31 | CAT-2 | M2HTH-BF20 | 27.0 | 0.090 | 600.0 | 176,147 | 87,956 | 2.0 | 18.9 | 105.0 |
| 32 | CAT-2 | M2HTH-BF20 | 23.8 | 0.090 | 680.7 | 195,807 | 115,383 | 1.7 | 17.7 | 102.2 |
| 33 | CAT-4 | MAO | 29.5 | 0.083 | 506.4 | 159,465 | 95,829 | 1.7 | 15.3 | 103.5 |
| 34 | CAT-4 | MAO | 28.1 | 0.082 | 525.3 | 166,043 | 100,040 | 1.7 | 14.5 | 105.3 |
| 35 | CAT-4 | MAO | 27.3 | 0.084 | 553.8 | 198,742 | 110,200 | 1.8 | 13.3 | 103.6 |
| 36 | CAT-4 | MAO | 27.9 | 0.084 | 541.9 | 195,650 | 101,201 | 1.9 | 13.4 | 103.8 |
| 37 | CAT-4 | DMAH-BF20 | 27.4 | 0.092 | 604.4 | 186,297 | 108,172 | 1.7 | 19.2 | 98.5 |
| 38 | CAT-4 | DMAH-BF20 | 25.9 | 0.094 | 653.3 | 204,188 | 126,407 | 1.6 | 20.3 | 101.2 |
| 39 | CAT-4 | DMAH-BF20 | 27.3 | 0.096 | 633.0 | 196,702 | 108,700 | 1.8 | 20.9 | 101.0 |
| 40 | CAT-4 | DMAH-BF20 | 25.3 | 0.094 | 668.8 | 213,653 | 109,937 | 1.9 | 18.3 | 100.9 |
| 41 | CAT-4 | Act-BF20 | 24.3 | 0.100 | 740.7 | 184,924 | 101,114 | 1.8 | 21.1 | 101.0 |
| 42 | CAT-4 | Act-BF20 | 25.1 | 0.102 | 731.5 | 202,336 | 97,610 | 2.1 | 21.4 | 100.0 |
| 43 | CAT-4 | Act-BF20 | 24.0 | 0.093 | 697.5 | 188,955 | 107,455 | 1.8 | 21.0 | 100.0 |
| 44 | CAT-4 | Act-BF20 | 30.3 | 0.099 | 588.1 | 186,022 | 109,410 | 1.7 | 22.3 | 100.2 |
| 45 | CAT-4 | M2HTH-BF20 | 23.9 | 0.096 | 723.0 | 175,510 | 95,963 | 1.8 | 20.9 | 99.9 |
| 46 | CAT-4 | M2HTH-BF20 | 21.7 | 0.094 | 779.7 | 197,360 | 111,387 | 1.8 | 19.9 | 100.0 |
| 47 | CAT-4 | M2HTH-BF20 | 25.1 | 0.092 | 659.8 | 186,042 | 96,541 | 1.9 | 19.3 | 104.3 |
| 48 | CAT-4 | M2HTH-BF20 | 26.5 | 0.092 | 624.9 | 201,538 | 109,044 | 1.8 | 19.2 | 100.7 |

### Solubility of Activators

Solubility studies procedure: A saturated solution of each of the catalysts was prepared by stirring an excess of the catalyst (20-40 mg) in 1 mL of solvent (isohexane or methylcyclohexane) for 30 minutes at 25° C. The mixture was filtered through a syringe filter and a known volume of the filtrate was evaporated to dryness in a tared vial. In the case of the high-solubility CAT-3, the isohexane was then slowly removed from the prepared solution via a strong flow of nitrogen until any insolubility or haziness appeared. The solutions were evaporated almost to dryness and no insolubility was visible. The solubility of the catalysts is summarized in Table 3.

TABLE 3
Solubility data of catalysts

| | Solubility | Solubility | Solubility | Solubility |
|---|---|---|---|---|
| | limit in | limit in | limit in | limit in |
| | isohexane | MeCy | isohexane | MeCy |
| Catalyst | (mM) | (mM) | (wt %) | (wt %) |
| CAT-1 | <1 | <1 | <0.1 | <0.1 |
| CAT-2 | 20 | 140 | 2.8 | 17 |
| CAT-3 | >390 | >410 | >45 | >40 |
| CAT-4 | 12 | 105 | 1.7 | 13 |

### Supported Catalyst Preparation

All catalyst preparations were done in an atmosphere of dry nitrogen. Solvents were degassed and dried over molecular sieves.

SMAO Preparation. Methylalumoxane (MAO, 30 wt % in toluene, 891 grams) and 1,800 grams of toluene were added together in a 4 L stirred reactor. This solution was stirred at 60 RPM for 5 minutes. ES70 silica (741 grams, PQ Corporation, Malvern, Pennsylvania, calcined to 875° C. under a flow of N₂) was added. The slurry was heated at 100° C. and stirred at 120 RPM for 3 hours. The temperature was reduced to 25° C. and cooled to temperature over 2 hours. Once cooled, the vessel was stirred at 8 RPM and placed under vacuum for 60 hours.

Scavenger Preparation (AlMe3 on Silica). 850 grams of ES70 silica (PQ Corp) dehydrated at 100° C. was loaded into a 4 L stirred reactor and slurried with 4 L of pentane. Trimethylaluminum (250 g) was added dropwise by addition funnel over 30 minutes. The solution was stirred at 120 rpm for 2 hours. The solvent was removed overnight in vacuo at room temperature. The product was removed from the mixer and rinsed with 2 L of pentane on a filter frit. The product was placed back in the mixer to dry in vacuo at room temperature for 4 hours.

Methylcyclohexane (9.70 mL) was added to OMC5598 (182 mg) to form a 20 μmol/mL solution.

### Supported Catalyst 1

To a rapidly stirring slurry of SMAO (1.38 g) in 25 mL pentane was added 2.76 mL of the OMC5598 solution in 7 portions. This was stirred for 20 minutes at room temp then the solid was isolated by filtration, washed with pentane (ca. 10 ml) and dried under vacuum.

### Supported Catalyst 2

3.42 mL of the OMC5598 solution was added to (n-propylcyclopentadienyl)(1-methyltetrahydroindenyl)zirconiumdimethyl (24.5 mg) and further diluted with 10 mL pentane. This was added dropwise to a rapidly stirring slurry of SMAO (1.71 g) in 25 mL pentane. It was stirred for 20 minutes then isolated by filtration; washed with 10 mL pentane and dried under vacuum.

### Polymerization

A 2 L autoclave was heated at 110° C. for 1 hour and then charged, under N₂, with solid NaCl (350 g), 6 grams of scavenger and heated for 30 minutes at 120° C. The reactor was then cooled to −81° C. 1-Hexene (2.5 mL) and 10% H₂ in N₂ (120 SCCM) were added, and stirring was then commenced (450 RPM). Supported catalysts were injected into the reactor with ethylene flow (200 psi). After the injection, the reactor temperature was controlled at and ethylene allowed to flow into the reactor to maintain pressure. Both 10% H₂ in N₂ and 1-hexene were fed in ratio to the ethylene flow. The polymerization was halted after 60 minutes by venting the reactor. The polymer was washed twice with water to remove salt and then dried in air for at least two days.

TABLE 4
Semi-batch poylmerization testing in salt-bed reactor.

| | | 10% | | | | | |
|---|---|---|---|---|---|---|---|
| | | H₂ | H₂/C₂ | C₆ | C₆/C₂ | Cata- | |
| Ex- | Cata- | Charge | Feed | Charge | Feed | lyst | Productivity |
| ample | lyst | (sccm) | (mg/g) | (mL) | (g/g) | (mg) | (gPgcat⁻¹hr⁻¹) |
| 1 | 1 | 120 | 0.5 | 2.5 | 0.1 | 12.7 | 3347 |
| 2 | 2 | 120 | 0.5 | 2.5 | 0.1 | 12.0 | 7167 |
| 3 | 1 | 650 | 1.95 | 1.0 | 0.01 | 13.1 | 2527 |
| 4 | 2 | 650 | 1.95 | 1.0 | 0.01 | 13.9 | 4201 |

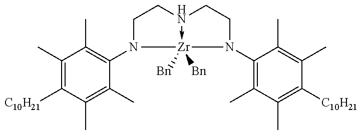

C10-HN5
OMC5598 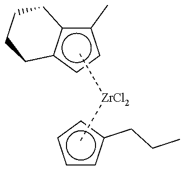
Y-2 MCN
(n-propylcyclopentadienyl)(1-
methyltetrahydroindenyl)zirconiumdimethyl

All documents described herein are incorporated by reference herein, including any priority documents and/or testing procedures to the extent they are not inconsistent with this text. As is apparent from the foregoing general description and the specific embodiments, while forms of the invention have been illustrated and described, various modifications can be made without departing from the spirit and scope of the invention. Accordingly, it is not intended that the invention be limited thereby. Likewise, the term “comprising” is considered synonymous with the term “including.” Likewise whenever a composition, an element or a group of elements is preceded with the transitional phrase “comprising”, it is understood that we also contemplate the same composition or group of elements with transitional phrases “consisting essentially of,” “consisting of”, “selected from the group of consisting of,” or “is” preceding the recitation of the composition, element, or elements and vice versa.

What is claimed is:

1. A non-aromatic hydrocarbon soluble catalyst compound represented by the Formula (X): 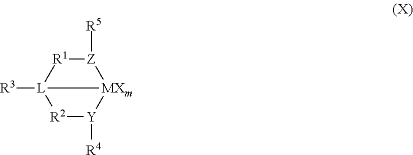
wherein:
M is a Group 4 metal;
each X is independently a leaving group, such as an anionic leaving group;
m is 1, 2 or 3;
L is a Group 15 or 16 element;
Y and Z are independently phosphorus, nitrogen sulfur, or oxygen;
R¹ and R² are, independently, a C₁ to C₂₀ hydrocarbon group, a heteroatom containing group having up to twenty carbon atoms, silicon, germanium, tin, lead, or phosphorus, R¹ and R² may also be interconnected to each other directly or bound to each other through other groups);
R³ may be absent or may be a hydrocarbon group, a hydrogen, a halogen, a heteroatom containing group; and
each R⁴ and R⁵ is independently a substituted C₅ to C₂₂ aromatic group,
wherein the catalyst compound is soluble in methylcyclohexane at greater than 10 weight percent at 25° C.

2. The non-aromatic hydrocarbon soluble catalyst compound of claim 1, wherein the catalyst compound is soluble in isohexane at greater than 1.5 weight at 25° C.

3. The non-aromatic hydrocarbon soluble catalyst compound of claim 1, wherein R¹ and R² are, independently, a C₁, C₂ or C₃ hydrocarbon group.

4. The non-aromatic hydrocarbon soluble catalyst compound of claim 1, wherein the catalyst compound is absent aromatic hydrocarbon.

5. The non-aromatic hydrocarbon soluble catalyst compound of claim 1, wherein each R⁴ and R⁵ is independently a C₆ to C₂₂ substituted phenyl group, a C₆ to C₂₂ substituted benzyl group, a C₆ to C₂₂ substituted naphthyl group, or a C₆ to C₂₂ substituted anthracenyl group.

6. The non-aromatic hydrocarbon soluble catalyst compound of claim 1, wherein each R⁴ and R⁵ is independently a hydrocarbyl substituted phenyl group represented by the formula: 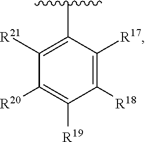
where each of R¹⁷, R¹⁸, R²⁰, and R²¹ is independently selected from hydrogen, C₁-C₄₀ hydrocarbyl or C₁-C₄₀ substituted hydrocarbyl, a heteroatom or a heteroatom-containing group, or two or more of R¹⁷, R¹⁸, R¹⁹, R²⁰, and R²¹ are joined together to form a C₄-C₆₂ cyclic or polycyclic ring structure, or a combination thereof;
each R¹⁹ is independently selected from C₃-C₂₂ hydrocarbyl or C₁-C₂₂ substituted hydrocarbyl, a heteroatom or a heteroatom-containing group.

7. The non-aromatic hydrocarbon soluble catalyst compound of claim 6, wherein each R¹⁹ is independently one or more of C₃ to C₁₆ linear or branched alkyl.

8. The non-aromatic hydrocarbon soluble catalyst compound of claim 6, wherein each R¹⁹ is independently one or more of propyl, butyl, pentyl, hexyl, heptyl, octyl, nonyl, decyl, undecyl, dodecyl, tridecyl, tetradecyl, pentadecyl, hexadecyl, heptadecyl, phenyl, methylphenyl and dimethylphenyl, benzyl, methylbenzyl, naphthyl, cyclohexyl, cyclohexenyl, methylcyclohexyl or an isomer thereof.

9. The non-aromatic hydrocarbon soluble catalyst compound of claim 1, wherein each X is, independently, selected from the group consisting of hydrocarbyl radicals having from 1 to 20 carbon atoms, hydrides, amides, alkoxides, sulfides, phosphides, halides, dienes, amines, phosphines, ethers, and a combination thereof, or two X's form a part of a fused ring or a ring system.

10. The non-aromatic hydrocarbon soluble catalyst compound of claim 1, wherein the compound is represented by Formula (XII): 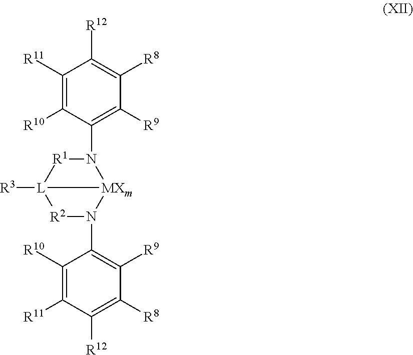
wherein:
M is a zirconium, titanium, or hafnium;
each X is independently a leaving group;
m is 1, 2 or 3;
R¹ and R² are, independently, a C₁ to C₃ hydrocarbon group, a heteroatom containing group having up to twenty carbon atoms, silicon, germanium, tin, lead, or phosphorus;
R³ may be absent or may be a hydrocarbon group, a hydrogen, a halogen, a heteroatom containing group;
each R⁸, R⁹, R¹⁰, and R¹¹ is independently hydrogen, a C₁ to C₁₆ alkyl group, a heteroatom, or a heteroatom containing group containing up to 16 carbon atoms; and
each R¹² is independently hydrogen, a C₃ to C₁₆ alkyl group, a substituted C₃ to C₁₆ alkyl group, a C₆ to C₁₆ aryl group, or a substituted C₆ to C₁₆ aryl group.

11. The non-aromatic hydrocarbon soluble catalyst compound of claim 1, wherein the catalyst compound comprises one or more of:
[N′-(2,3,5,6-tetramethyl-4-dodceyl-phenyl)-N-[2-(2,3,5,6-tetramethyl-4-dodecyl-phenyl)amino-κN]ethyl]-1,2-ethane-diaminato(2-)κN,κN′]zirconium dichloride;
[N′-(2,3,5,6-tetramethyl-4-decyl-phenyl)-N-[2-(2,3,5,6-tetramethyl-4-decyl-phenyl)amino-κN]ethyl]-1,2-ethane-diaminato(2-)κN,κN′]zirconium dichloride;
[N′-(2,3,5,6-tetramethyl-4-tetradecyl,-phenyl)-N-[2-(2,3,5,6-tetramethyl-4-tetradecyl,-phenyl)amino-κN]ethyl]-1,2-ethane-diaminato(2-)κN,κN′]zirconium dichloride;
[N′-(2,3,5,6-tetramethyl-4-hexadecyl,-phenyl)-N-[2-(2,3,5,6-tetramethyl-4-hexadecyl,-phenyl)amino-κN]ethyl]-1,2-ethane-diaminato(2-)κN,κN′]zirconium dichloride;
[N′-(2,3,5,6-tetramethyl-4-octadecyl,-phenyl)-N-[2-(2,3,5,6-tetramethyl-4-octadecyl,-phenyl)amino-κN]ethyl]-1,2-ethane-diaminato(2-)κN,κN′]zirconium dichloride;
[N′-(2,3,5,6-tetramethyl-4-eicosyl,-phenyl)-N-[2-(2,3,5,6-tetramethyl-4-eicosyl,-phenyl)amino-κN]ethyl]-1,2-ethane-diaminato(2-)κN,κN′]zirconium dichloride;
[N′-(2,3,5,6-tetramethyl-4-docosyl,-phenyl)-N-[2-(2,3,5,6-tetramethyl-4-docosyl,-phenyl)amino-κN]ethyl]-1,2-ethane-diaminato(2-)κN,κN′]zirconium dichloride;
[N′-(2,3,5,6-tetramethyl-4-dodceyl-phenyl)-N-[2-(2,3,5,6-tetramethyl-4-dodecyl-phenyl)amino-κN]ethyl]-1,2-ethane-diaminato(2-)κN,κN]zirconium dibenzyl;
[N′-(2,3,5,6-tetramethyl-4-decyl-phenyl)-N-[2-(2,3,5,6-tetramethyl-4-decyl-phenyl)amino-κN]ethyl]-1,2-ethane-diaminato(2-)κN,κN]zirconium dibenzyl; and
[N′-(4-decyl-phenyl)-N-[2-(4-decyl-phenyl)amino-κN]ethyl]-1,2-ethane-diaminato (2-)κN,κN′]zirconium dibenzyl.

12. A catalyst system comprising activator, optional support, and non-aromatic hydrocarbon soluble catalyst compound of claim 1.

13. The catalyst system of claim 12 wherein the catalyst system is absent aromatic hydrocarbon.

14. The catalyst system of claim 12 wherein the catalyst system is supported.

15. A process to polymerize olefins comprising contacting one or more olefins with the catalyst system of claim 12.

16. The process of claim 15 wherein the process is absent aromatic hydrocarbon.

17. The process of claim 15 wherein the process occurs at a temperature of from about 0° C. to about 300° C., at a pressure in the range of from about 0.35 MPa to about MPa, and at a time up to 300 minutes.

18. The process of claim 15 further comprising obtaining polymer.

19. The process of claim 15 wherein the process occurs in the gas or slurry phase.

20. The process of claim 15 wherein the process occurs in the solution phase.
